(19) United States
(12) Patent Application Publication
(10) Pub. No.: US 2026/0056049 A1
(43) Pub. Date: Feb. 26, 2026

(54) DETECTION DEVICE

(71) Applicant: NIKON CORPORATION, Tokyo (JP)

(72) Inventor: Shiro TSUNAI, Kawasaki-shi (JP)

(73) Assignee: NIKON CORPORATION, Tokyo (JP)

(21) Appl. No.: 19/102,468

(22) PCT Filed: Aug. 15, 2023
(86) PCT No.: PCT/JP2023/029501

§ 371 Date: Feb. 10, 2025

(30) Foreign Application Priority Data
Aug. 19, 2022 (JP) 2022-131239

(51) Int. Cl. G01J 1/04; G01J 1/44

(52) U.S. Cl. CPC G01J 1/0425; G01J 1/44; G01J 2001/446

(57) ABSTRACT

In order to detect a subject in a lensless manner, this detection device has: a light guide unit having a light incidence opening for entry of light and a light emission opening smaller in size than the light incidence opening, the light entering through the light incidence opening being emitted through the light emission opening; and a detection unit configured to detect the light emitted through the light emission opening.

### INCORPORATION BY REFERENCE

The present application claims priority from Japanese patent application JP 2022-131239 filed on Aug. 19, 2022, the content of which is hereby incorporated by reference into this application.

### TECHNICAL FIELD

The present invention pertains to a detection device.

### BACKGROUND ART

Imaging devices provided with a technique for performing subject detection through signals from an imaging element have been well-known. Improvement in subject detection accuracy has been desired even in conventional configurations.

### RELATED ART DOCUMENTS

### Patent Documents

Patent Document 1: JP 2006-197192 A

### SUMMARY

A detection device according to an aspect of the present disclosure comprises: a light guide unit having a light incidence opening for entry of light and a light emission opening smaller in size than the light incidence opening, the light entering through the light incidence opening being emitted through the light emission opening; and a detection unit configured to detect the light emitted through the light emission opening.

### BRIEF DESCRIPTION OF THE DRAWINGS

FIG. 1 is a descriptive drawing showing one example of a detection device according to Embodiment 1.

FIG. 2A is a descriptive view showing example 1 of the incident angle dependence of directly incident light on the detection device.

FIG. 2B is a descriptive view showing example 2 of the incident angle dependence of directly incident light on the detection device 100.

FIG. 2C is a descriptive view showing example 3 of the incident angle dependence of directly incident light on the detection device.

FIG. 3 is a descriptive view showing the incident angle dependence of directly incident light or reflected incident light on the detection device.

FIG. 4 is a descriptive view showing another configuration example of the interior of the frustum section.

FIG. 5A is a component-side cross-sectional view of a detection device according to Embodiment 2.

FIG. 5B is an external view showing two adjacent light guide units.

FIG. 6 is a component plan view of the detection device according to Embodiment 2.

FIG. 7 is a descriptive view showing an arrangement gap example 1 of the plurality of light guide units.

FIG. 8 is a graph showing MTF characteristics in relation to the arrangement angle and the incident angle of the incident light.

FIG. 9 is a descriptive view showing an arrangement gap example 2 of the plurality of light guide units.

FIG. 10 is a descriptive view showing an arrangement gap example 3 of the plurality of light guide units.

FIG. 11 is a component plan view of the detection device according to Embodiment 4.

FIG. 12 is a perspective view of a detection device according to Embodiment 5.

FIG. 13 is a side view of the detection device according to Embodiment 5.

FIG. 14 is a plan view and a cross-sectional view along the line AB of a first holding board.

FIG. 15 is a plan view and a cross-sectional view along the line CD of a second holding board.

FIG. 16 is a descriptive drawing showing one example of a manufacturing system for a light guide component according to Embodiment 6.

FIG. 17 is a perspective view showing an example of a light guide component formed by the manufacturing system.

FIG. 18 is a descriptive view showing a connection example of the light guide component.

FIG. 19 is a descriptive view showing an example of another to-be-machined item.

FIG. 20 is a front view and a plan view showing another example of a light guide component formed by the manufacturing system.

FIG. 21 is a front view and a bottom view showing another example of a light guide component formed by the manufacturing system.

FIG. 22 is a descriptive view showing a connection example of the light guide component.

FIG. 23 is a perspective view showing an example of a structure according to Embodiment 7.

FIG. 24 is a first cross-sectional view of the structure according to Embodiment 7.

FIG. 25 is a second cross-sectional view of the structure according to Embodiment 7.

FIG. 26 is another first cross-sectional view of the structure according to Embodiment 7.

### DETAILED DESCRIPTION OF EMBODIMENTS

### Embodiment 1

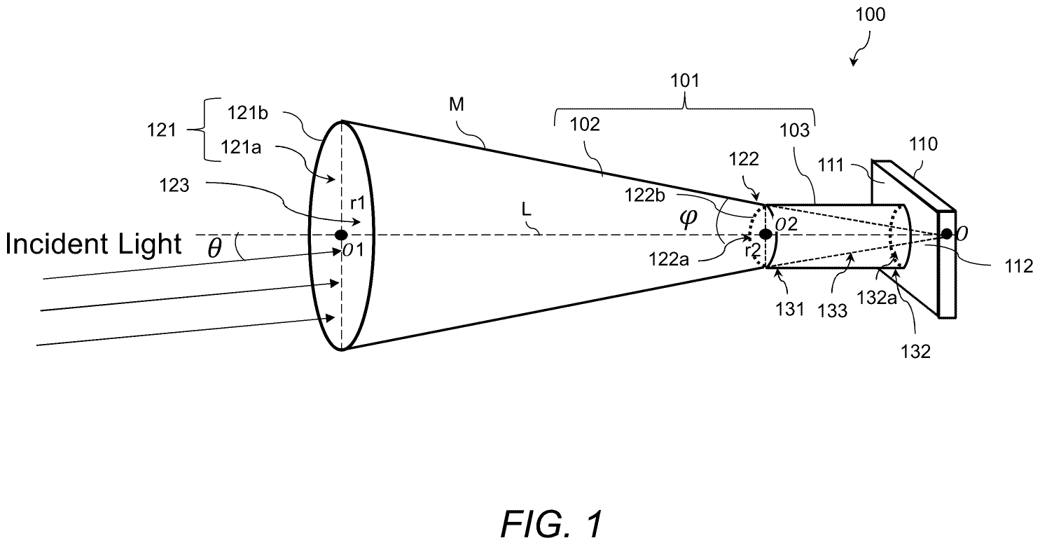

FIG. 1 is a descriptive drawing showing one example of a detection device according to Embodiment 1. A detection device 100 has a light guide unit 101, and a detection unit 110. The light guide unit 101 allows therethrough incident light from a subject, and emits the incident light to the detection unit 110. The detection unit 110 has photodiodes, and performs photoelectric conversion on the light emitted from the light guide unit 101. Below, the light guide unit 101 and the detection unit 110 will be described in detail.

The light guide unit 101 has a frustum section 102 and a transmission section 103. The frustum section 102 and the transmission section 103 may be connected to each other or may be formed integrally. The frustum section 102 has a light incidence section 121 on one end and a light emission section 122 on the other end.

The light incidence section 121 has a light incidence opening 121a and an edge 121b. The light incidence opening 121a is an opening through which light enters, the center thereof being designated as O1 and the radius that is the distance from the center O1 to the edge 121b being designated as r1. The edge 121b is the contour of the light incidence opening 121a. The incident light from the light incidence opening 121a passes into the frustum section 102. The surface of the light incidence opening 121a (opening surface) and the area of the opening surface are designated as S1.

The light emission section 122 has an opening 122a and an edge 122b that are continuous with one end of the transmission section 103. The center of the opening 122a is designated as O2 and the radius that is the distance from the center O2 to the edge 122b is designated as r2 (<r1). The edge 122b is the contour of the opening 122a. The light emitted from the opening 122a passes into the transmission section 103. The surface of the opening 122a (opening surface) and the area of the opening surface are designated as S2. The opening 122a has the same shape as the light incidence opening 121a.

The internal circumferential surface of the frustum section 102 may be an absorbing surface that absorbs the incident light or may be a reflective surface that reflects the incident light. The interior of the frustum section 102 may be hollow or may be a transparent body that passes light.

Here, the frustum section 102 is a solid body formed by removing a cone with O as the vertex and the opening 122a of the light emission section 122 as the bottom surface, from a cone with O as the vertex and the light incidence opening 121a of the light incidence section 121 as the bottom surface. That is, the frustum section 102 has a penetrating hole 123 formed from the light incidence opening 121a to the opening 122a. The vertex O is not necessarily present on a surface 111 of the detection unit 110, but for ease of depiction, the vertex O is disposed at the center of the surface 111 in FIG. 1.

The line segment linking O, O1, and O2 is designated as L. The generatrix of the cone having the point O as the vertex and the light incidence opening 121a of the light incidence section 121 as the bottom surface is designated as M. The incident angle of the incident light in relation to the line segment L is designated as e. The angle formed between the line segment L and the generatrix M is q. The generatrix M is a line segment linking the point O to the edge 121b of the light incidence section 121.

The transmission section 103 is a column with a hollow interior, or in other words, a tube body. A first end 131 of the transmission section 103 is connected to the light emission section 122. A second end 132 of the transmission section 103 has a light emission opening 132a through which the incident light is emitted to the detection unit 110, and is connected to the detection unit 110. The opening of the first end 131 and the opening of the second end 132 of the transmission section 103 have the same shape and size. The inner surface of the transmission section 103 efficiently transmits the incident light to the light emission section 122 through total reflection and internal reflection. The penetrating hole from the first end 131 to the second end 132 of the transmission section 103 is referred to as a transmission path 133.

The detection unit 110 has a flat plate shape. The surface 111 of the detection unit 110 is connected to the second end 132 of the transmission section 103. The inner surface of the surface 111 surrounded by the edge of the second end 132 is a light reception surface 112 that receives light transmitted inside the transmission section 103. The inside of the light reception surface 112 is provided with a photoelectric conversion unit.

The detection unit 110 performs photoelectric conversion of the light received at the light reception surface 112 using photodiodes, and outputs an electrical signal. The photodiodes are made of silicon or indium gallium arsenide, for example. The electrical signal is outputted to an image processing unit (not shown). The image processing unit executes image processing on the basis of the electrical signal and displays a subject image in a display unit (not shown). The image processing unit and the display unit may be provided in the detection device 100, or may be provided in a computer that is external to the detection device 100 and can communicate therewith. The detection unit 110 may have the function of amplifying light.

Since the transmission section 103 is a tube, the light reception surface 112 has substantially the same surface and has the same area as the opening 122a of the light emission section 122. Thus, S2 is sometimes used to refer to the light reception area for convenience. The relationship between the opening area S1 and the light reception area S2 is indicated by the following equation (1).

$$D = S 2 / S 1 \qquad ( 1 )$$

D is the light reception surface ratio.

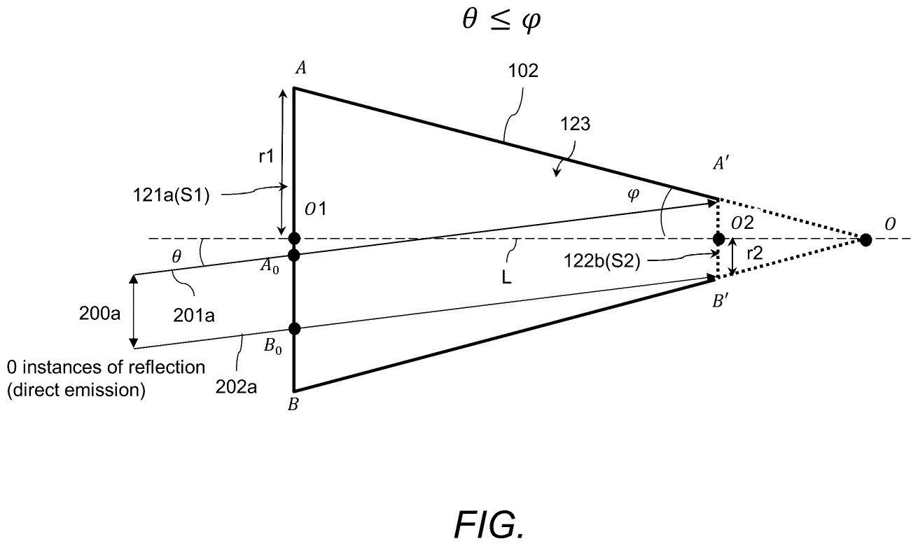

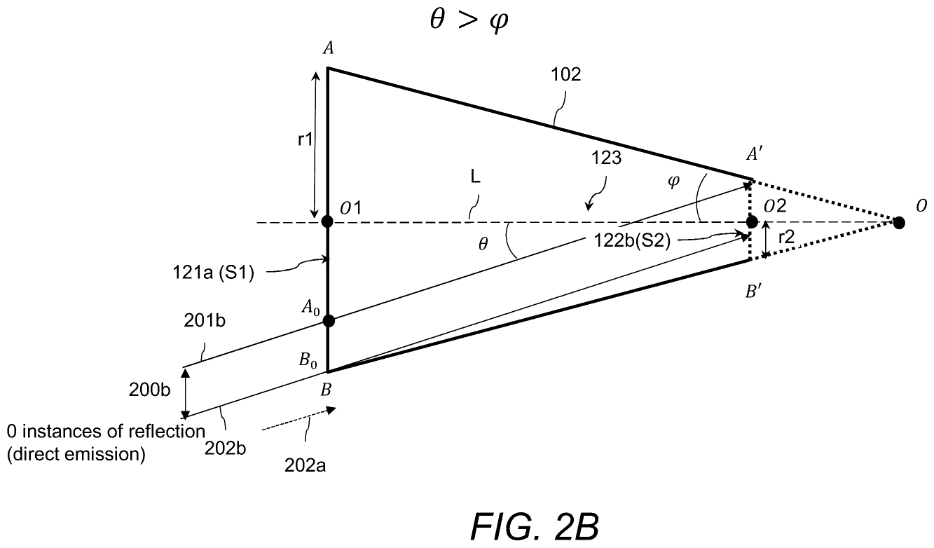

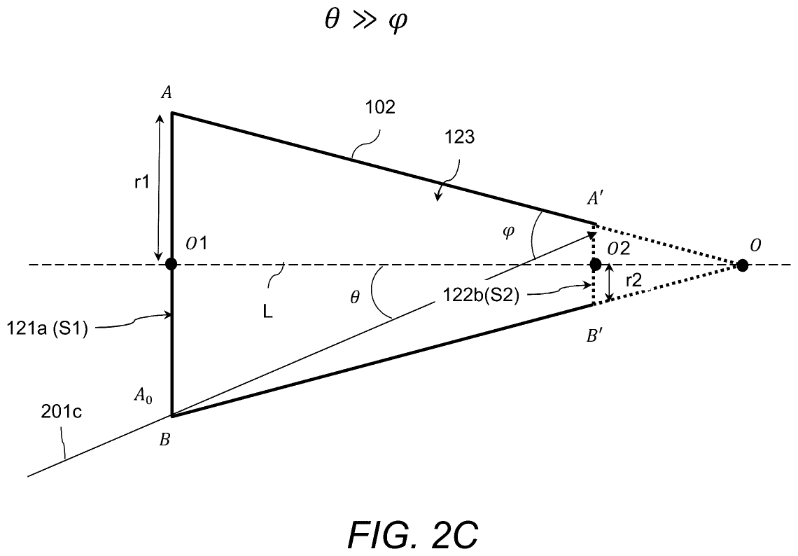

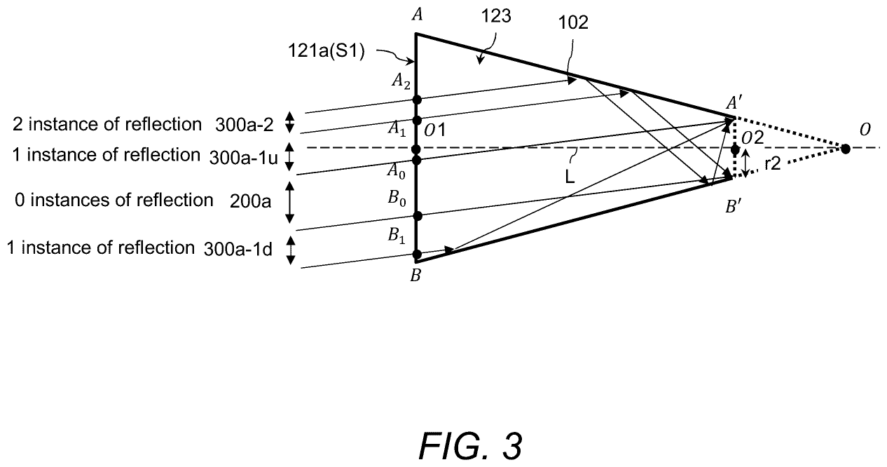

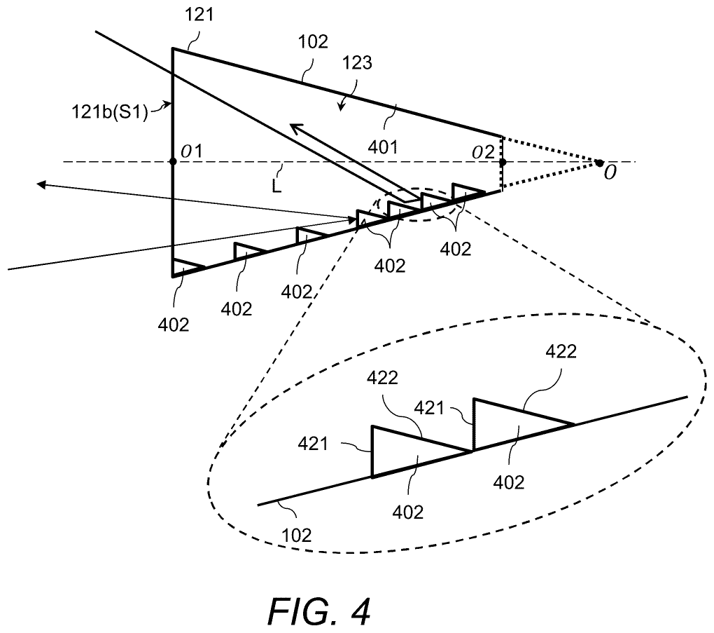

FIGS. 2A to 2C are descriptive views showing examples 1 to 3 of the incident angle dependence of directly incident light on the detection device 100. FIGS. 2A to 2C (as well as FIGS. 3 and 4) depict a cross section of the frustum section 102 along a plane perpendicular to the circumferential direction of the light incidence opening 121a and the opening 122a. A and B are points on the edge 121b, and AB signifies the area S1 or the surface with the area. In FIGS. 2A to 2C, 200a to 200c are light fluxes. If not distinguishing between 200a to 200c, the light fluxes are collectively referred to as the light fluxes 200. The reference characters 201a to 201c, 202a, and 202b are light beams defining the edges of the light fluxes 200. If not distinguishing between 201a to 201c, the light beams are collectively referred to as the light beams 201. If not distinguishing between 202a and 202b, the light beams are collectively referred to as the light beams 202.

A₀ is the intersection point between the light beam 201 that is directly incident from the subject and the opening surface S1 of the light incidence opening 121a, and B₀ is the intersection point between the light beam 202 that is directly incident from the subject and the opening surface S1 of the light incidence opening 121a. A₀B₀ indicates the area of intersection between the opening surface S1 and the fluxes of directly incident light A₀ to B₀, or refers to the surface where such intersection occurs. A′ and B′ are points on the edge 122b, and A′B′ signifies the area S2 or the surface with the area.

The suffix “0” in A₀ and B₀ indicates the number of reflections in the frustum section 102 of the light passing through A₀ and B₀. To generalize, the number of reflections is i or j (i and j being non-negative integers), with the reference characters being Aᵢ, Bⱼ.
(a) is the incident angle dependence for when θ≤φ, (b) is the incident angle dependence for when θ>φ, and (c) is the incident angle dependence for when θ>>φ. In the case of (a), the light flux 200a of the area A₀B₀ reaches the opening 122a without being reflected in the frustum section 102. That is, in (a), the area A₀B₀=S2. Thus, a light reception angle characteristic I₀(θ) under the direct emission of (a) is represented by the following equation (2).

$${I}_{0} ( θ ) = {A}_{0} {B}_{0} / AB = {A}^{′} {B}^{′} / AB \qquad ( 2 )$$

In the case of FIG. 2B, not all of the light flux 200a of FIG. 2A can enter the light incidence opening 121a, and the light flux 200b, from the resulting light loss, enters the light incidence opening 121a. Thus, when the light beam 202b enters the opening 122a, vignetting occurs at B. The light flux 200b of the area A₀B₀ reaches the opening 122a without being reflected in the frustum section 102. That is, in FIG. 2B, the area A₀B₀<S2.

In the case of FIG. 2C, not all of the light flux 200 of FIG. 2A can enter the light incidence opening 121a, and the light beam 201c enters the light incidence opening 121a. If θ>>φ to an even greater degree, then none of the light flux 200 enters the opening 122a.

FIG. 3 is a descriptive view showing the incident angle dependence of directly incident light or reflected incident light on the detection device 100. Reflected light fluxes 300a-1u and 300a-1d (if not distinguishing therebetween, referred to as the reflected incident light 300a-1) is reflected incident light that enters through the light incidence opening 121a, is reflected once inside the frustum section 102, and reaches the opening 122a. A reflected light flux 300a-2 is reflected incident light that enters through the light incidence opening 121a, is reflected twice inside the frustum section 102, and reaches the opening 122a.

The reflected light flux 300a-1u passes through the surface A₀A₁. The reflected light flux 300a-1d passes the surface B₀B₁. The reflected light flux 300a-2 passes through the surface A₁A₂.

The light reception angle characteristic that takes into consideration the reflected light is represented by the following equation (3).

$$\begin{matrix}[ Formula 1 ] & \\ I ( θ ) = \frac{{A}_{0} {B}_{0} + {\sum }_{i = 1} {R}^{i} {A}_{i} {A}_{i - 1} + {\sum }_{j = 1} {R}^{j} {B}_{j} {B}_{j - 1}}{A B} & ( 3 )\end{matrix}$$

In equation (3), Rⁱ is the reflectance at the ith reflection inside the frustum section 102. R^{j} is the reflectance at the jth reflection inside the frustum section 102. The reflectances Rⁱ and R^{j} decrease, the greater the reflection counts i and j are.

FIG. 4 is a descriptive view showing another configuration example of the interior of the frustum section 102. Light reception prevention members 402 are provided in at least a portion of the internal circumferential surface 401 of the frustum section 102. The light reception prevention member 402 reflects incident light 400, and emits the incident light 400 through the light incidence opening 121a of the light incidence section 121. Each of the light reception prevention members 402 is a ring- or arc-shaped member extending in the circumferential direction of the opening 122a. The cross-sectional shape of the light reception prevention member 402 along the plane perpendicular to the circumferential direction is similar to the cross-sectional shape of the frustum section 102 along the plane perpendicular to the circumferential direction.

As shown in FIG. 4, the light reception prevention members 402 each have a first surface 421 and a second surface 422. The first surface 421 faces the light incidence opening 121a, and reflects the incident light, which is emitted from the light incidence opening 121a. The second surface 422 reflects the incident light to the first surface 421 of another light reception prevention member 402 further towards the opening 122a.

Thus, according to Embodiment 1, it is possible to realize clear subject detection without the use of a lens. Also, according to Embodiment 1, it is possible to realize subject detection with a high directivity, or in other words, a deep depth of field and no focusing required.

In Embodiment 1, the shape of the light incidence opening 121a and the opening 122a were set to be circular as an example, but the shape may instead be polygonal. In this case, the cross-sectional shapes of the frustum section 102 and the transmission section 103 along the plane perpendicular to the line segment L would be the same polygonal shape.

In Embodiment 1, a transparent member may be provided in the light incidence opening 121a. As an example of the transparent member, by sealing the light incidence opening 121a with a transparent plastic member, it is possible to increase dust prevention properties inside the frustum section 102 and the transmission section 103 while maintaining subject detection capabilities. Additionally, as an example of the transparent member, by sealing the light incidence opening 121a with a lens, it is possible to increase light condensing properties for the incident light and dust prevention properties inside the light guide unit 101 while maintaining subject detection capabilities.

### Embodiment 2

Next, Embodiment 2 will be described. In Embodiment 1, an example was described of a case in which one light guide unit 101 was provided, but in Embodiment 2, an example in which a plurality of light guide units 101 are provided will be described. The same components as Embodiment 1 are assigned the same reference characters and descriptions thereof are omitted.

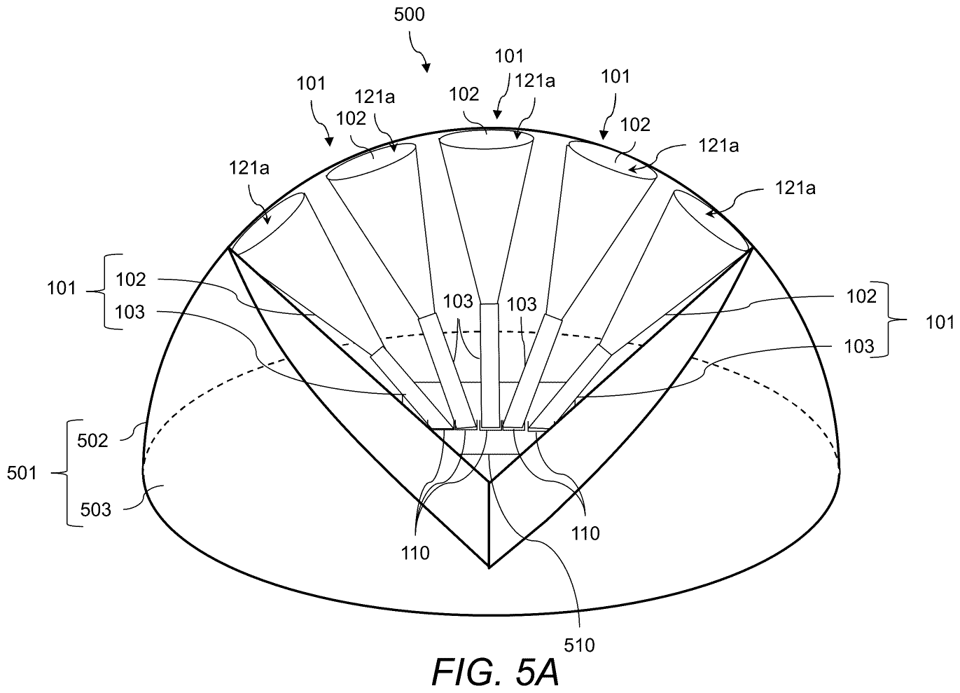

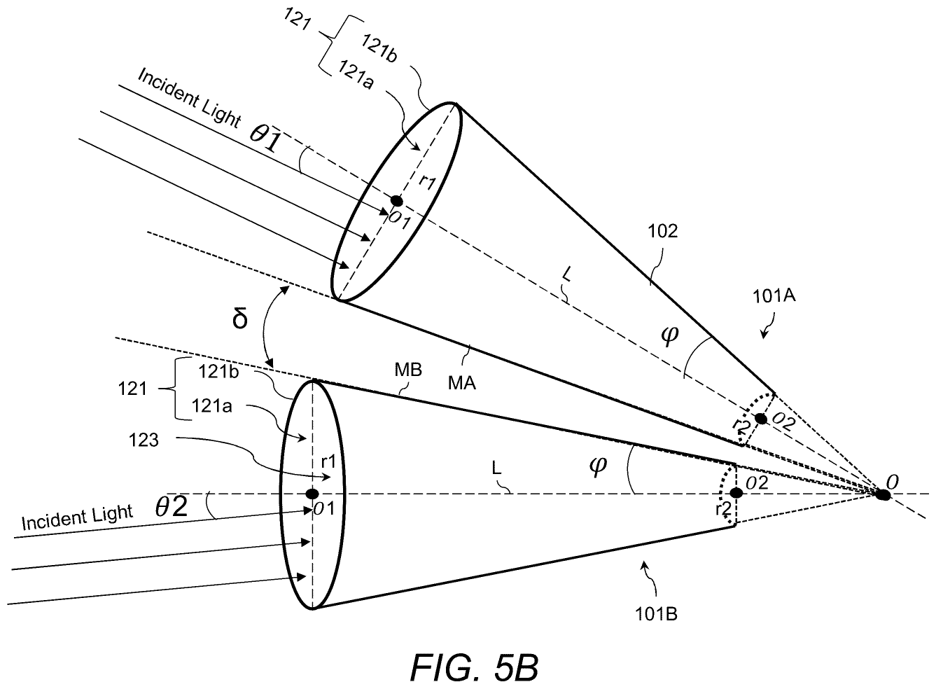

FIG. 5A is a component-side cross-sectional view of a detection device according to Embodiment 2. A detection device 500 has a semi-spherical case 501. The case 501 has a semi-spherical surface 502 and a bottom surface 503. The bottom surface 503 is a circular plate that seals the opening of the semi-spherical surface 502. Inside the case 501, a detection processing unit 510 is provided at the center above the bottom surface 503.

The detection processing unit 510 is a collection of detection units 110 respectively connected to each of the plurality of light guide units 101. Regions on the surface of the detection processing unit 510 connected to the respective transmission sections 103 each constitute a photodiode that is a detection unit 110 forming a pixel. The photodiodes are arranged in two dimensions. The second end 132 of each transmission section 103 is configured such that the edge face of the second end 132 is parallel to the surface of the detection processing unit 510.

Each of the light guide units 101 is provided radially from the detection processing unit 510 towards the semi-spherical surface 502. In FIG. 5, for ease of explanation, five light guide units 101 are provided radially. Adjacent frustum sections 102 are disposed at a gap from each other. The light incidence opening 121a is positioned on the semi-spherical surface 502. Openings may be formed at the positions of the semi-spherical surface 502 corresponding to the light incidence openings 121a. Also, the semi-spherical surface 502 may have a structure that seals in the light incidence openings 121a with a transparent member. A light-shielding member may be formed at regions of the semi-spherical surface 502 other than where the light incidence openings 121a are located.

FIG. 5B is an external view showing two adjacent light guide units 101. In FIG. 5B, one of the two adjacent light guide units 101 is designated as the light guide unit 101A, and the other is designated as the light guide unit 101B. Also, the adjacent generatrices M of the light guide units 101A and 101B are designated as generatrices MA and MB. The angle formed between the generatrices MA and MB is designated as an arrangement angle δ, which is the arrangement angle between the light guide units 101A and 101B.

If a lens is added to the light incidence opening 121a, it is possible to narrow the direction (limitation) of the incident light using the lens, which allows for a smaller arrangement angle δ compared to a case where no lens is provided. Thus, compared to a case where no lens is provided, more light guide units 101 can be disposed, allowing for high-resolution image acquisition.

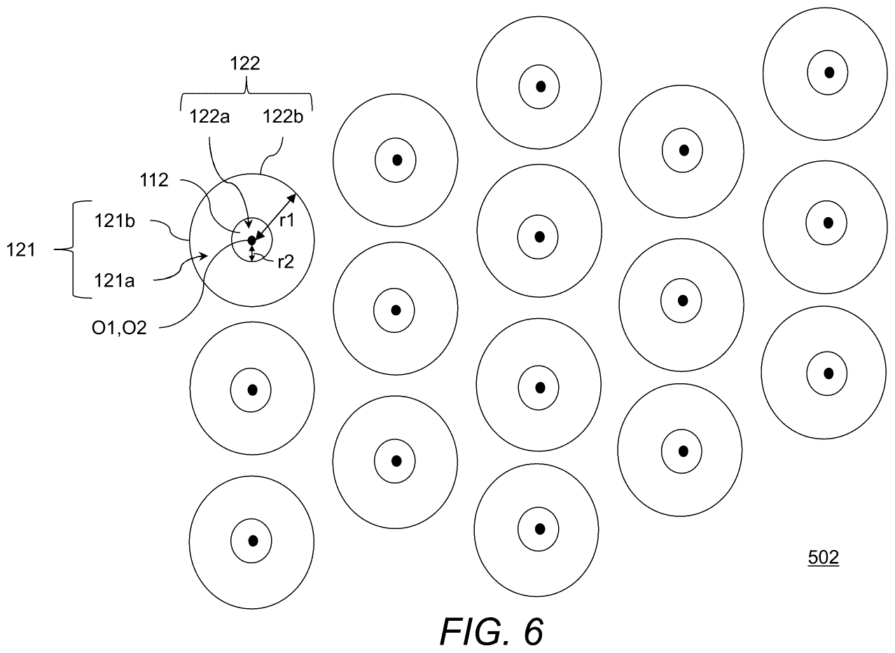

FIG. 6 is a component plan view of the detection device 500 according to Embodiment 2. The edges 121b and 122b are circles centered on points O1 and O2, respectively. The distance from the point O1 to a first light incidence edge that is a position on the edge 121b is a radius r1 of the edge 121b, and the distance from the point O1 to a second light incidence edge (at a position differing from the first light incidence edge) that is a position on the edge 121b is also the radius r1. Similarly, the distance from the point O2 to a first light emission edge that is a position on the edge 122b is a radius r2 of the edge 122b, and the distance from the point O2 to a first light emission edge (at a position differing from the first light emission edge) that is a position on the edge 122b is also the radius r2.

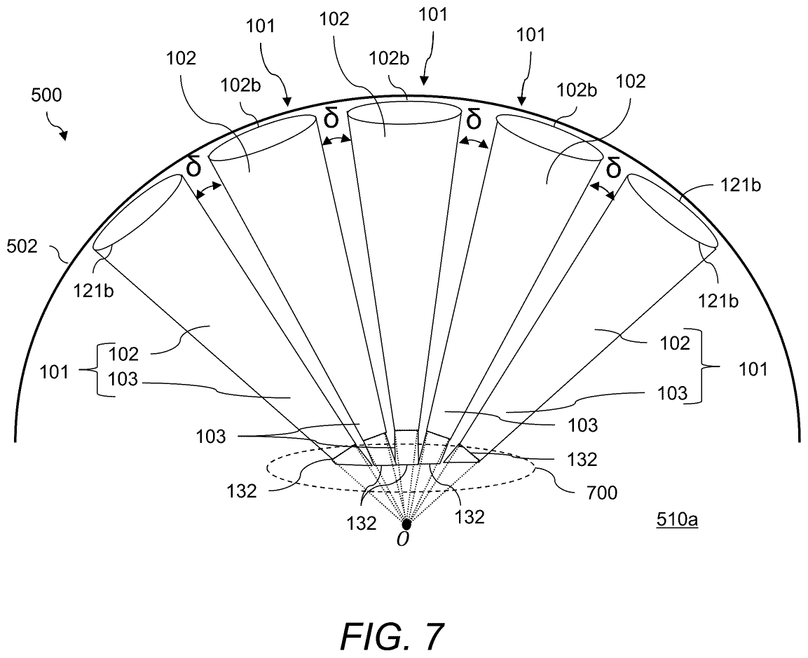

FIG. 7 is a descriptive view showing an arrangement gap example 1 of the plurality of light guide units 101. The plurality of light guide units 101 are arranged radially from a surface 700 of the detection processing unit 510. The second end 132 of each transmission section 103 is connected to the surface 700 of the detection processing unit 510.

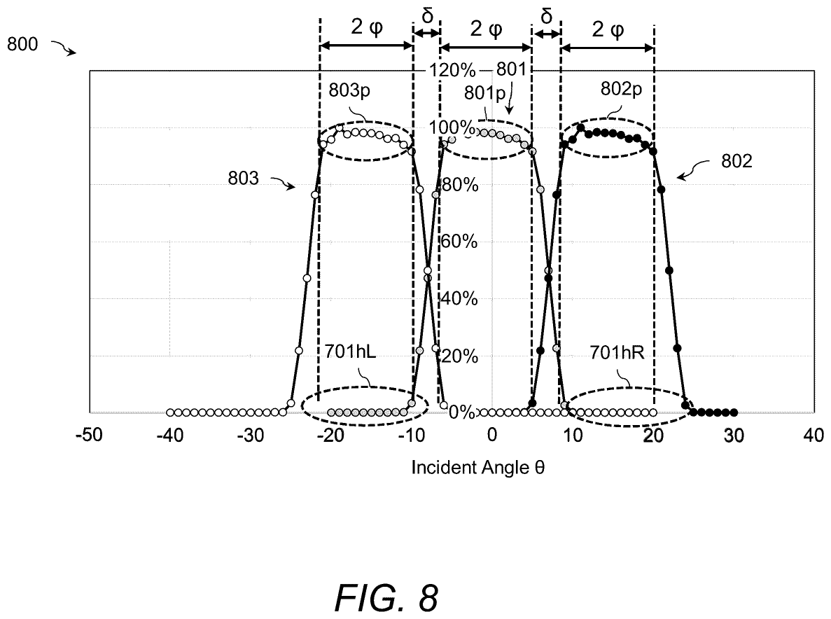

FIG. 8 is a graph showing MTF characteristics in relation to the arrangement angle δ and the incident angle θ of the incident light. In the graph 800, the horizontal axis is the incident angle θ of the incident light and the vertical axis is the modulation transfer function (MFT). The waveforms 801 to 803 indicate the MTF characteristics of each light guide unit 101. The light guide unit 101 of the waveform 801 is adjacent to the light guide unit 101 of the waveform 802, and the light guide unit 101 of the waveform 801 is adjacent to the light guide unit 101 of the waveform 803. The waveforms 801 to 803 are formed at a period of 2φ+δ. In this equation, 2φ is the opening angle of the frustum section 102.

The MTF is calculated by the following equation . . . (4).

$$MTF = ( response in opening angle ( 2 φ ) of light guide unit 101 ) / ( opening angle ( 2 φ ) of light guide unit 101 + response outside of angle from adjacent light guide unit 101 ) \qquad ( 4 )$$

For example, the range of the incident angle θ of the peak 802p of the waveform 802 includes the incident angle θ of the trough 801hR of the waveform 801 (response outside angle from adjacent light guide unit 101) and does not include the incident angle θ of the peak 801p of the waveform 801. Similarly, the range of the incident angle θ of the peak 803p of the waveform 803 includes the incident angle θ of the trough 801hL of the waveform 801 (response outside angle from adjacent light guide unit 101) and does not include the incident angle θ of the peak 801p of the waveform 801.

That is, at each peak 801p to 803p, MTF=100%, and thus, the incident light in the light guide unit 101 of the waveform 801 does not leak to the light guide units 101 at the adjacent waveforms 802 and 803. Thus, by manufacturing the detection device 500 by setting φ and θ so as to form the waveforms 801 to 803 of the graph 800, it is possible to improve subject detection accuracy.

### Embodiment 3

Next, Embodiment 3 will be described. In Embodiment 2, the length of the transmission section 103 in the lengthwise direction is the same for all of the light guide units 101, but in Embodiment 3, the lengths of the light guide units 101 differ according to the arrangement position. The same components as those of Embodiments 1 and 2 are assigned the same reference characters and descriptions thereof are omitted.

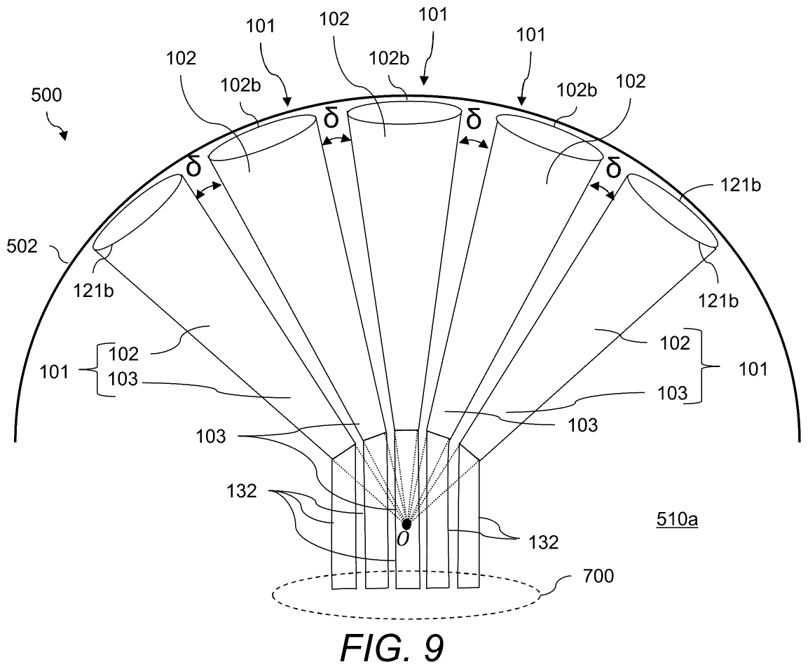

FIG. 9 is a descriptive view showing an arrangement gap example 2 of the plurality of light guide units 101. In FIG. 9, within the detection device 500, the transmission sections 103 positioned towards the inside (towards the center of the detection processing unit 510) are longer, and the transmission sections 103 positioned towards the outside are shorter. Each transmission section 103 is connected perpendicularly to the surface 700 of the detection processing unit 510. In this case, there are some light guide units 101 where the line segment L bends at the point O2, but the incident light is reflected within the transmission section 103 and guided towards the light reception surface 112. As a result, with the configuration of FIG. 9, the density of the transmission sections 103 is reduced compared to Embodiment 2, which allows for a reduction in the entry of incident light leaking from a nearby light guide unit 101.

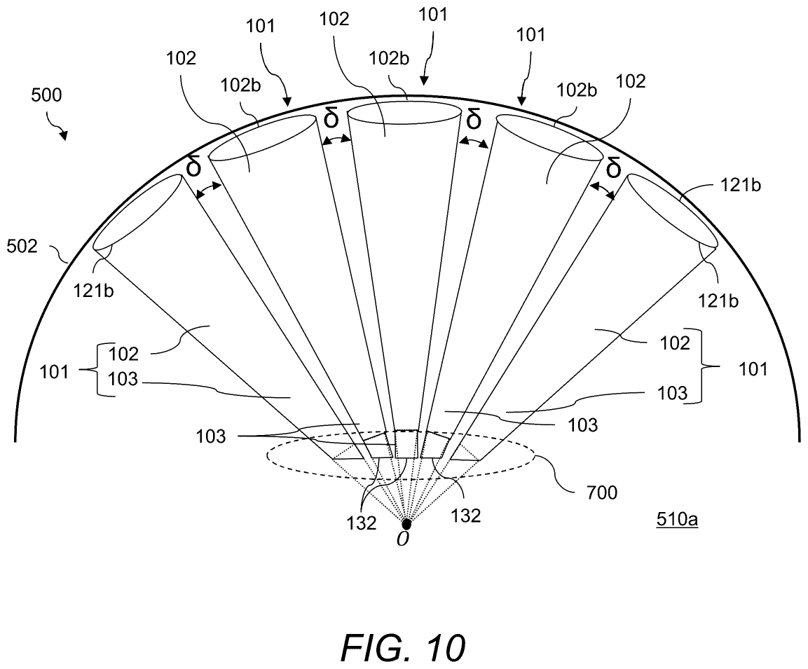

FIG. 10 is a descriptive view showing an arrangement gap example 3 of the plurality of light guide units 101. In FIG. 10, some of the light guide units 101 are not provided with the transmission section 103, and the light emission section 122 of the light guide unit 101 is directly connected to the surface 700 of the detection processing unit 510. In FIG. 10, the light guide units 101 that do not have the transmission section 103 are the light guide units 101L and 101R. An edge 122bL of the light emission section 122 of the light guide unit 101L is directly connected to the surface 700. Similarly, an edge 122bR of the light emission section 122 of the light guide unit 101R is also directly connected to the surface 700.

That is, the configuration of the light guide units 101L and 101R is determined such that emitted light from all of the light guide units 101 can be received by the flat surface 700. As a result of the configuration of FIG. 10, it is possible to reduce the number of components required as well as to reduce the size of the detection device 500. The configuration of the light guide units 101L and 101R of FIG. 10 can also be applied to Embodiment 1.

### Embodiment 4

Next, Embodiment 4 will be described. In Embodiments 1 to 3, the edges 121b and 122b are circular, but Embodiment 5 is an example in which the shape of the edges 121b and 122b is polygonal. The same components as Embodiments 1 to 3 are assigned the same reference characters and descriptions thereof are omitted.

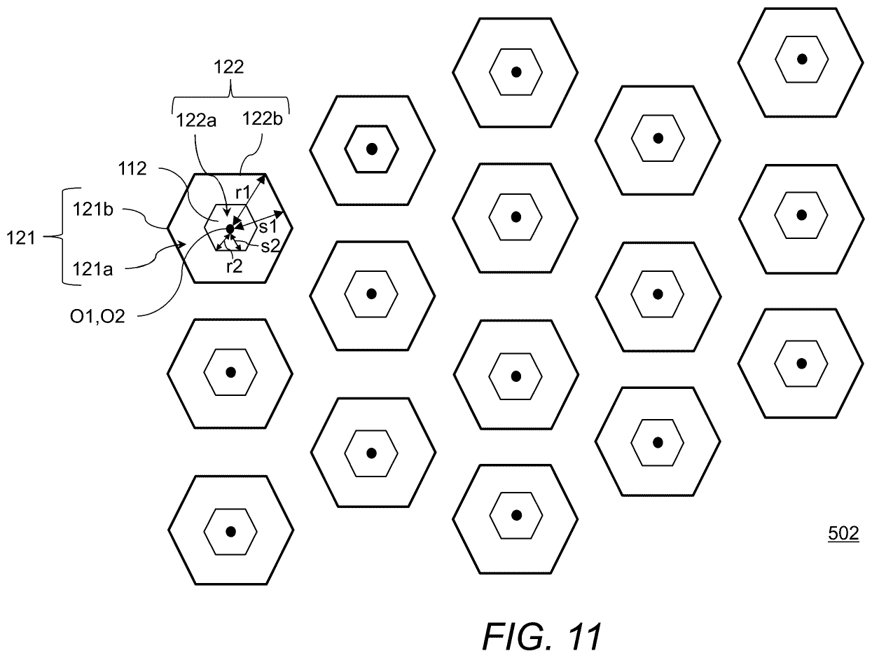

FIG. 11 is a component plan view of the detection device 500 according to Embodiment 4. In FIG. 11, the shape of the edge 121b is a regular hexagon instead of a circle.

The edges 121b and 122b are regular hexagons centered on points O1 and O2, respectively. In Embodiment 6, the distance from the point O1 to a first light incidence edge that is a vertex on the edge 121b is a radius r1, and the distance from the point O1 to a second light incidence edge that is a side of the edge 121b is s1 (<r1). Similarly, the distance from the point O2 to a first light emission edge that is a vertex of the edge 122b is a radius r2, and the distance from the point O2 to a second light emission edge that is a side of the edge 122b is s2 (<r2).

In FIG. 11, the shape of the edges 121b and 122b is regular hexagonal, but as long as s1<r1 and s2<r2 are satisfied, a polygon other than a regular hexagon may be used. Also, in Embodiment 5, the shape of the edges 121b and 122b from Embodiments 2 to 4 are configured to be polygonal, but the shape of the edges 121b and 122b in Embodiment 1 may also be polygonal.

Also, the transmission section 103 in this configuration is a tube with a hollow interior, and the internal circumferential surface of the tube may be processed to have metal plating so as to reflect light. Also, the transmission section 103 may be a tube having an optical fiber therein.

Thus, according to Embodiments 1-4, each detection unit 110 corresponds to each light guide unit 101 as a facet, and the detection unit 110 detects the intensity of the incident light from the light guide unit 101. The light guide units 101 are optically separated from each other, and as a result of each light guide unit 101 receiving incident light from one direction (the direction of the line segment L), it is possible to capture a broad ranging image with all of the plurality of light guide units 101. The closer the light guide units 101 are brought to the subject, the higher the resolution is, and the more detailed the image that can be captured is.

### Embodiment 5

Next, Embodiment 5 will be described. In Embodiment 5, a configuration for retaining the plurality of light guide units 101 indicated in Embodiments 1 to 4 will be described. The same components as Embodiments 1 to 4 are assigned the same reference characters and descriptions thereof are omitted.

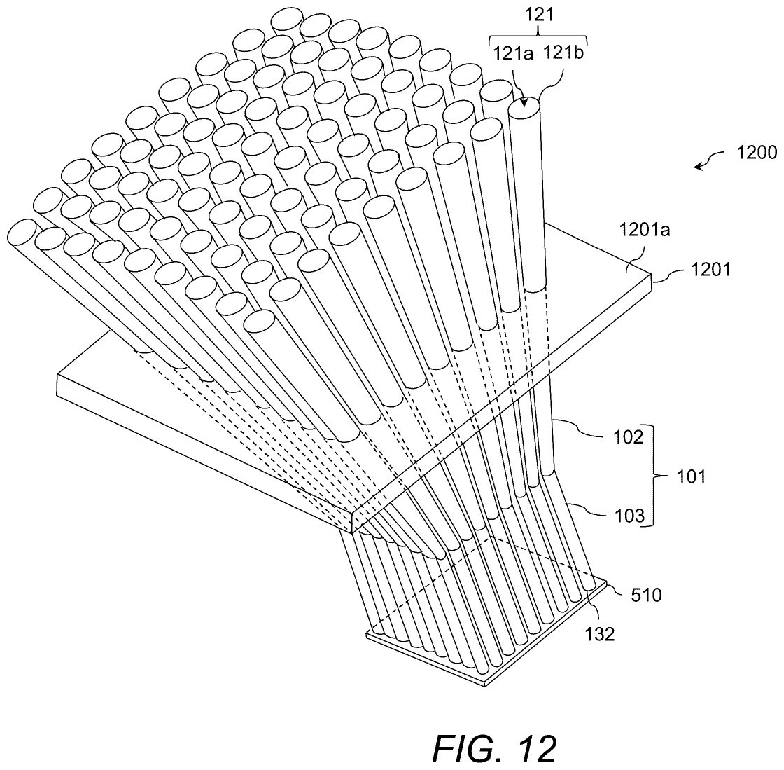

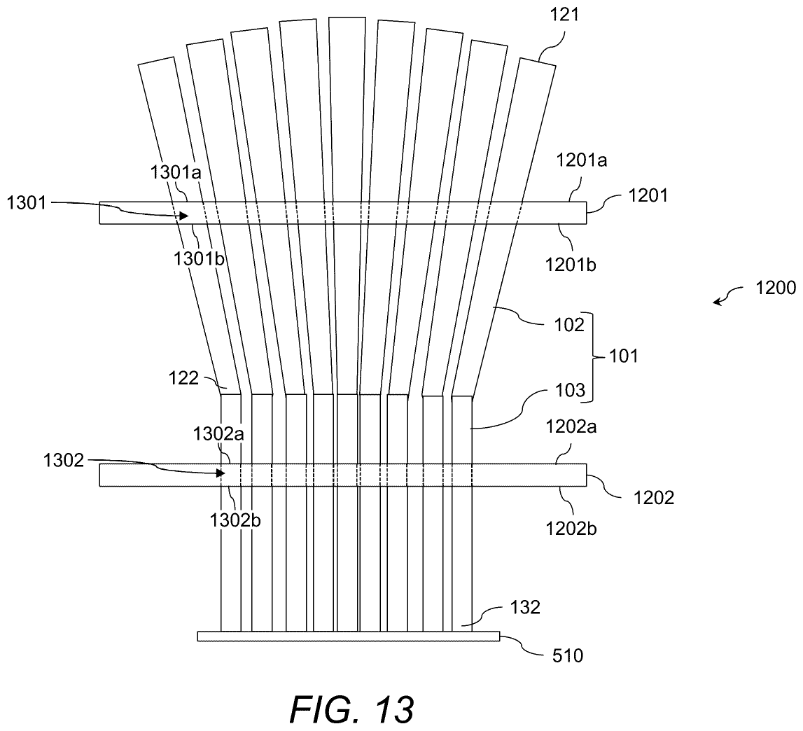

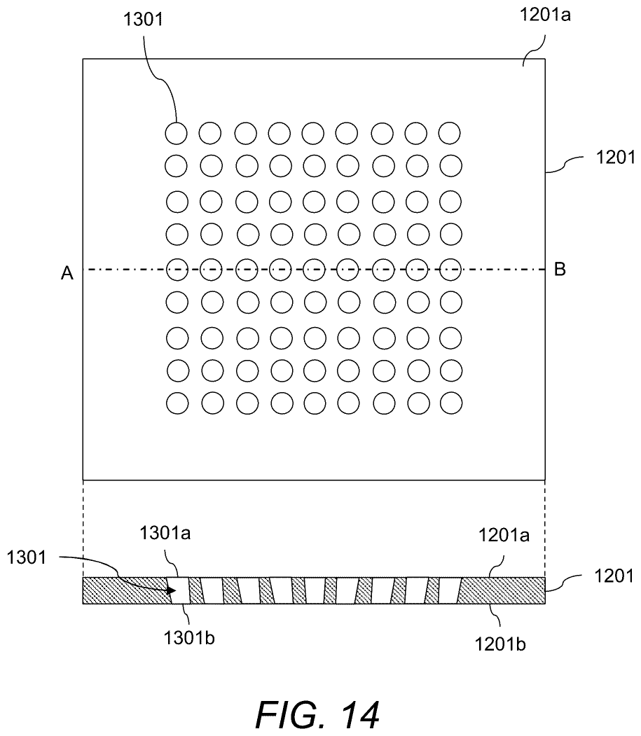

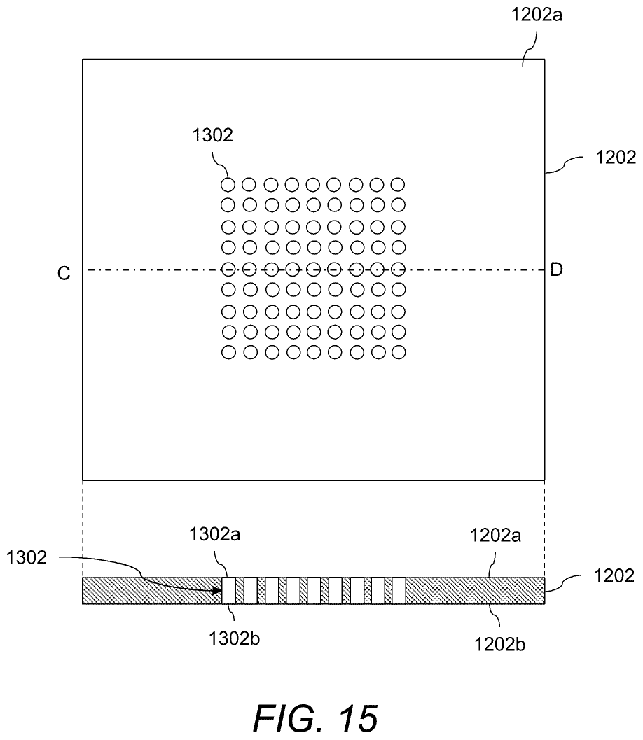

FIG. 12 is a perspective view of a detection device according to Embodiment 5. FIG. 13 is a side view of the detection device according to Embodiment 5. In FIG. 13, the light guide units 101 on the far side are omitted. FIG. 14 is a plan view and a cross-sectional view along the line AB of a first holding board. FIG. 15 is a plan view and a cross-sectional view along the line CD of a second holding board.

A detection device 1200 has a plurality of light guide units 101 (frustum section 102 and transmission section 103), a detection processing unit 510, a first holding board 1201, and a second holding board 1202 (in FIG. 12, the second holding board 1202 is omitted for ease of depiction). The plurality of light guide units 101 are arranged in a matrix such that the respective light incidence sections 121 are positioned on the same curved surface. The second end 132 of each transmission section 103 is connected to the detection processing unit 510.

The first holding board 1201 and the second holding board 1202 respectively hold the plurality of light guide units 101. The first holding board 1201 and the second holding board 1202 are plate-shaped members. The first holding board 1201 and the second holding board 1202 have a rectangular shape, but may be polygonal or circular. Also, a first front surface 1201a, a second front surface 1202a, a first rear surface 1201b, and a second rear surface 1202b of the first holding board 1201 and the second holding board 1202 may be flat surfaces or curved surfaces.

The first holding board 1201 and the second holding board 1202 are each disposed so as to intersect with the lengthwise direction of the light guide units 101. Specifically, the first holding board 1201 is provided with first penetrating holes 1301 at positions intersecting with the frustum sections 102, thereby allowing for insertion of the frustum sections 102, for example. Also, the second holding board 1202 is provided with second penetrating holes 1302 at positions intersecting with the transmission sections 103, thereby allowing for insertion of the transmission sections 103.

The detection device 1200 has at least one of the first holding board 1201 and/or the second holding board 1202.

The first holding board 1201 has a plurality of the first penetrating holes 1301. The plurality of first penetrating holes 1301 are provided at positions corresponding to the insertion positions for the plurality of frustum sections 102 arranged in a matrix. The first penetrating holes 1301 have a first upper edge 1301a and a first lower edge 1301b.

The first penetrating holes 1301 are holes that are formed between the first upper edge 1301a and the first lower edge 1301b. The first upper edge 1301a is provided in the first front surface 1201a and the first lower edge 1301b is provided in the first rear surface 1201b. The diameter of the first upper edge 1301a is greater than the diameter of the first lower edge 1301b.

Thus, the light emission section 122 of the frustum section 102 is inserted from the first upper edge 1301a and protrudes through the first lower edge 1301b, and the frustum section 102 is thereby held in the first penetrating hole 1301. Then, the frustum section 102 held in the first holding board 1201 by the first penetrating hole 1301 is connected to the transmission section 103.

The second holding board 1202 has a plurality of the second penetrating holes 1302. The plurality of first penetrating holes 1301 are provided at positions corresponding to the insertion positions for the plurality of transmission sections 103 arranged in a matrix. The second penetrating holes 1302 have a second upper edge 1302a and a second lower edge 1302b.

The second penetrating holes 1302 are holes that are formed between the second upper edge 1302a and the second lower edge 1302b. The second upper edge 1302a is provided in the second front surface 1202a and the second lower edge 1302b is provided in the second rear surface 1202b. The diameter of the second upper edge 1302a is the same as the diameter of the second lower edge 1302b.

Thus, a configuration may be adopted in which, prior to connection of the frustum section 102 to the detection processing unit 510, the transmission section 103 is inserted through the second upper edge 1302a and protrudes through the second lower edge 1302b, or is inserted through the second lower edge 1302b and protrudes through the second upper edge 1302a.

Also, prior to connection with the frustum section 102 but after connection with the detection processing unit 510, the transmission section 103 is inserted through the second upper edge 1302a and protrudes through the second lower edge 1302b. Additionally, prior to connection with the detection processing unit 510 but after connection with the frustum section 102, the transmission section 103 is inserted through the second upper edge 1302a and protrudes through the second lower edge 1302b.

The first holding board 1201 and the second holding board 1202 are held inside a case (not shown) of the detection device 1200.

In the detection device 1200, the light guide units 101 are constituted of the frustum sections 102 and the transmission sections 103, but the light guide units 101 may be constituted only of the frustum sections 102 instead. In this case, the detection processing unit 510 would be connected to the light emission sections 122.

The frustum section 102 is configured such that the diameter of the light incidence opening 121a is greater than the diameter of the light emission section 122, but the diameter of the light incidence opening 121a and the diameter of the light emission section 122 may be the same. This would result in the frustum section 102 having a cylindrical shape.

Thus, according to Embodiment 5, as a result of the plurality of light guide units 101 being held at the first holding board 1201 and/or the second holding board 1202, the plurality of light guide units 101 can be positioned with improved accuracy. As a result, the detection device 1200 can be manufactured with greater ease.

### Embodiment 6

Next, Embodiment 6 will be described. In Embodiment 6, a manufacturing method for the light guide unit will be described. The same components as Embodiments 1 to 5 are assigned the same reference characters and descriptions thereof are omitted.

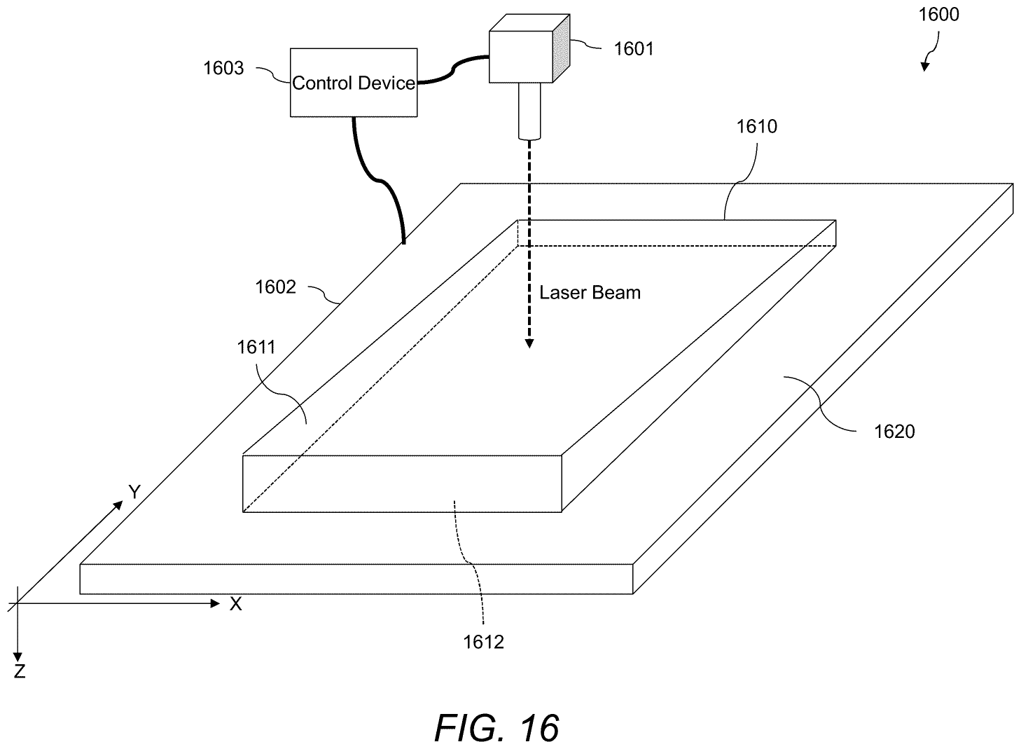

FIG. 16 is a descriptive drawing showing one example of a manufacturing system for a light guide component according to Embodiment 6. A manufacturing system 1600 has a laser beam machine 1601, an XY stage 1602, and a control device 1603. In FIG. 16, the X axis, the Y axis, and the Z axis are perpendicular to each other.

The laser beam machine 1601 emits a laser beam onto a to-be-machined item 1610. The laser beam machine 1601 emits a laser beam at a prescribed pulse width (e.g., a femtosecond pulse) onto the to-be-machined item 1610 in the Z axis direction to perform machining to a desired shape, thereby forming a groove.

The XY stage 1602 is a positioning platform that can move along the X axis and along the Y axis, which is perpendicular to the X axis. On the XY stage 1602, the to-be-machined item 1610 is fixed to a mounting surface 1620. The mounting surface 1620 is parallel to a plane defined by the X axis and the Y axis.

The control device 1603 executes emission time control of the laser beam from the laser beam machine 1601 and movement control of the XY stage 1602. The control device 1603 adjusts the depth of the groove in the Z axis direction by increasing or decreasing the emission time of the laser beam from the laser beam machine 1601, for example. Also, by causing the XY stage 1602 to move in the Y direction, the control device 1603 can form a groove along the Y direction in the to-be-machined item 1610 using the laser beam from the laser beam machine 1601, and by causing the XY stage 1602 to move in the X direction, the control device 1603 can adjust the width of the groove formed along the Y direction using the laser beam from the laser beam machine 1601, for example.

The size of the groove can be controlled by the power of the laser beam (emission diameter), the pulse count (time) for laser beam emission, and the positional movement of the XY stage 1602.

The emission time due to emission time control of the laser beam from the laser beam machine 1601 and the displacement timing thereof, and the movement quantity due to movement control of the XY stage 1602 and the timing thereof are set in advance by the control device 1603.

The to-be-machined item 1610 is a workpiece made of metal, glass, or a ceramic. The to-be-machined item 1610 is a plate-shaped workpiece with a trapezoidal cross-sectional shape along the YZ plane, for example. A rear surface 1612 and a front surface 1611 that is an inclined surface of the to-be-machined item 1610 are irradiation surfaces to be irradiated with the laser beam from the laser beam machine 1601. After the front surface 1611 is irradiated, a person or a mechanism (not shown) causes the to-be-machined item 1610 to be fixed in place such that the rear surface 1612 faces the laser beam machine 1601, for example.

The Z axis direction thickness of the to-be-machined item 1610 varies depending on the position in the Y axis direction. Thus, the control device 1603 controls the output of the laser beam machine 1601 to be greater and controls the movement of the XY stage 1602 such that the X axis direction width is greater, the thicker the to-be-machined item 1610 is in the Z axis direction.

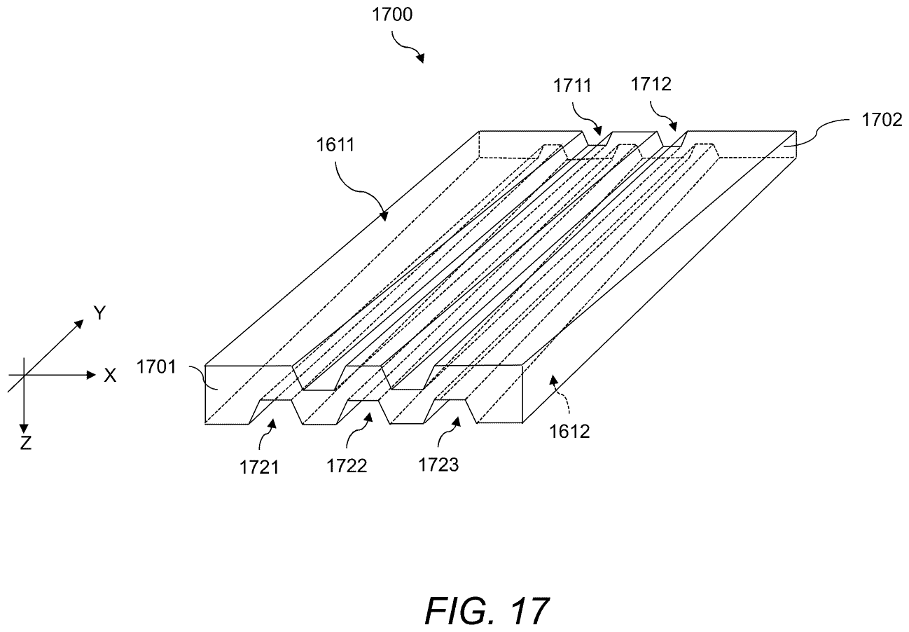

FIG. 17 is a perspective view showing an example of a light guide component formed by the manufacturing system 1600. A light guide component 1700 is produced as a result of the manufacturing system 1600 machining the to-be-machined item 1610. That is, first grooves 1711 and 1712 are formed in the front surface 1611 of the light guide component 1700 and second grooves 1721 to 1723 are formed in the rear surface 1612.

The first grooves 1711 and 1712 and the second grooves 1721 to 1723 are substantially trapezoidal, for example, and are machined such that the shape thereof becomes gradually smaller from a front edge face 1701 to a rear edge face 1702. The first grooves 1711 and 1712 and the second grooves 1721 to 1723 may be semicircular.

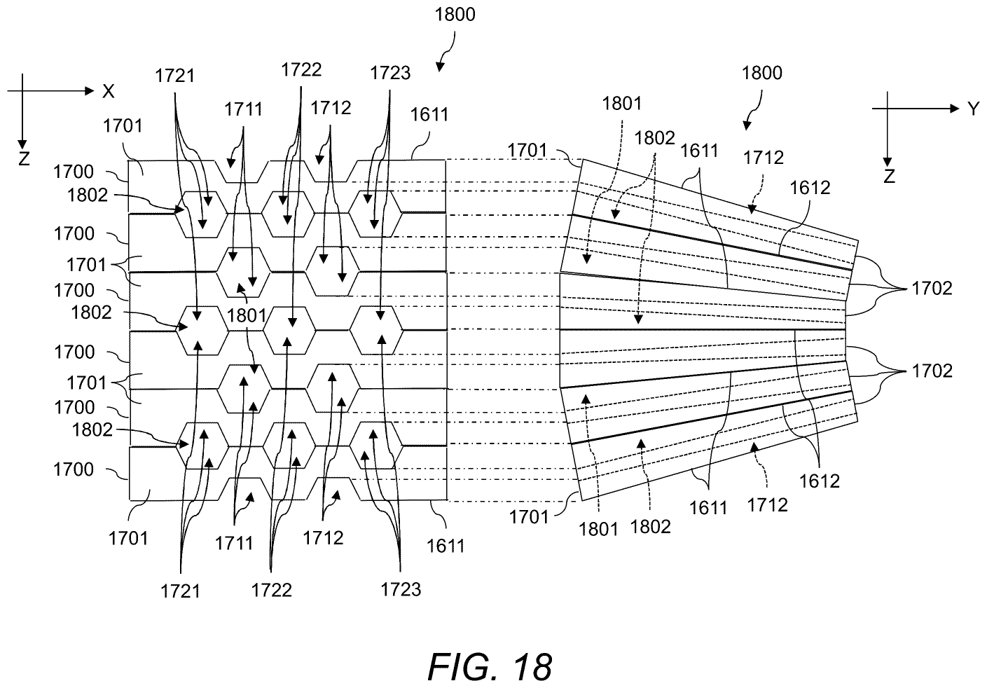

FIG. 18 is a descriptive view showing a connection example of the light guide component 1700. FIG. 18 shows a structure 1800 formed by stacking six light guide components 1700 in the Z axis direction. Specifically, six light guide components 1700 are stacked in the Z axis direction as a result of the front surfaces 1611 or the rear surfaces 1612 of two light guide components 1700 adjacent to each other in the Z axis direction being connected to each other, for example.

As a result of the front surfaces 1611 of two light guide components 1700 adjacent to each other in the Z axis direction being connected, the first grooves 1711 and 1712 of the light guide components 1700 face each other, thereby forming first penetrating holes 1801. Similarly, as a result of the rear surfaces 1612 of two light guide components 1700 adjacent to each other in the Z axis direction being connected, the second grooves 1721 to 1723 of the light guide components 1700 face each other, thereby forming second penetrating holes 1802. In the structure 1800, the first penetrating holes 1801 and the second penetrating holes 1802 are the light guide units 101 or the frustum sections 102.

Two adjacent light guide components 1700 are connected to each other by screw or by pressure. If screws are used, a screw hole that penetrates six light guide components 1700 is formed. By shortening the pulse width of the laser beam, it is possible to mitigate the formation of burrs in the front surface 1611 and the rear surface 1612 of the to-be-machined item 1610 during machining, thereby mitigating the formation of gaps between two adjacent light guide components 1700.

In the structure 1800, the front edge face 1701 of each light guide component 1700 is the light-receiving surface and the rear edge face 1702 of each light guide component 1700 is the light-emitting surface. Below, the plurality of linked front edge faces 1701 are referred to as the light-receiving surface 1701 and the plurality of linked rear edge faces 1702 are referred to as the light-emitting surface 1702.

Light enters from the openings of the first penetrating holes 1801 and the second penetrating holes 1802 formed in the light-receiving surface 1701, and is emitted from the openings of the first penetrating holes 1801 and the second penetrating holes 1802 formed in the light-emitting surface 1702.

The structure 1800 is applied to the detection device 100 as the plurality of light guide units 101 described in Embodiments 1 to 4. Specifically, the light-emitting surface 1702 of the structure 1800 is connected to the detection processing unit 510, for example. More specifically, the detection unit 110 is connected to each of the openings of the first penetrating holes 1801 and the second penetrating holes 1802 on the side of the light-emitting surface 1702. As a result, it is possible to receive light passing through the first penetrating holes 1801 and the second penetrating holes 1802.

Also, the structure 1800 may be applied to the detection device 100 as the plurality of frustum sections 102 described in Embodiments 1 to 4. In this case, the first end 131 of the transmission section 103 is connected to each of the openings of the first penetrating holes 1801 and the second penetrating holes 1802 on the side of the light-emitting surface 1702, and the detection unit 110 is connected to each of the second ends 132 of the transmission sections 103. As a result, it is possible to receive light passing through the first penetrating holes 1801, the second penetrating holes 1802, and the transmission sections 103.

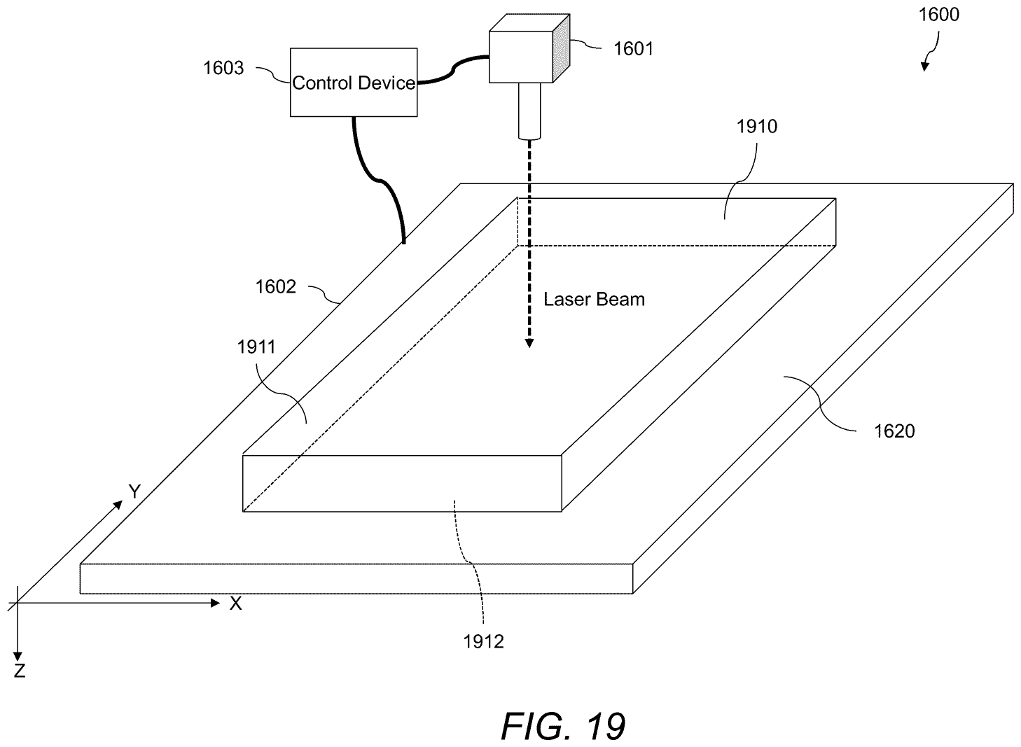

FIG. 19 is a descriptive view showing an example of another to-be-machined item. The to-be-machined item 1910 is a rectangular cuboid, and thus, differs in shape from the to-be-machined item 1610. A front surface 1911 and a rear surface 1912 of the to-be-machined item 1910 are irradiation surfaces to be irradiated with the laser beam from the laser beam machine 1601. After the front surface 1911 is irradiated, a person or a mechanism (not shown) causes the to-be-machined item 1610 to be fixed in place such that the rear surface 1912 faces the laser beam machine 1601, for example.

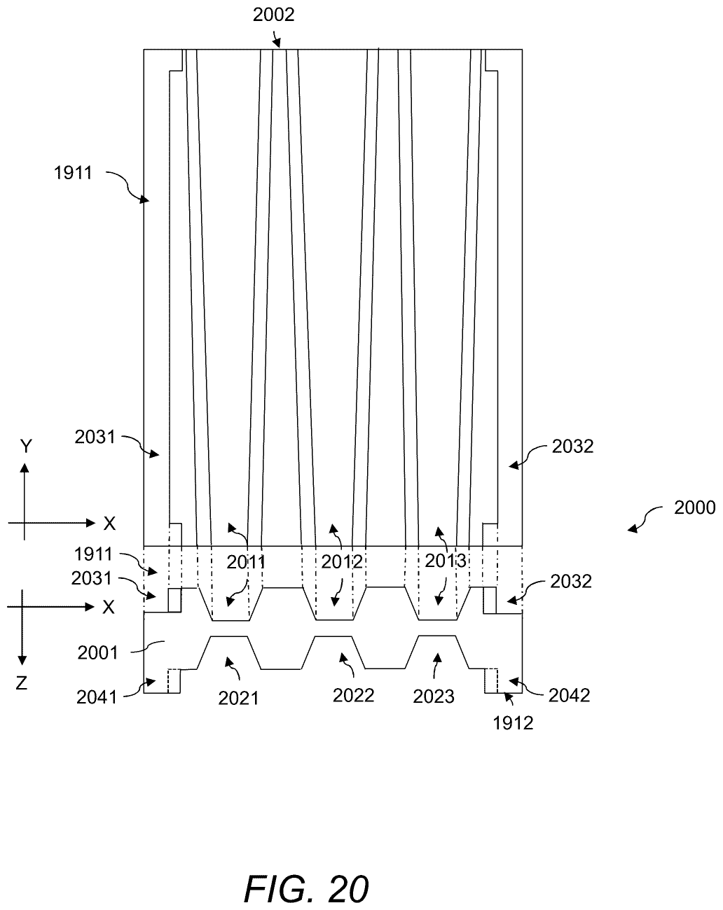

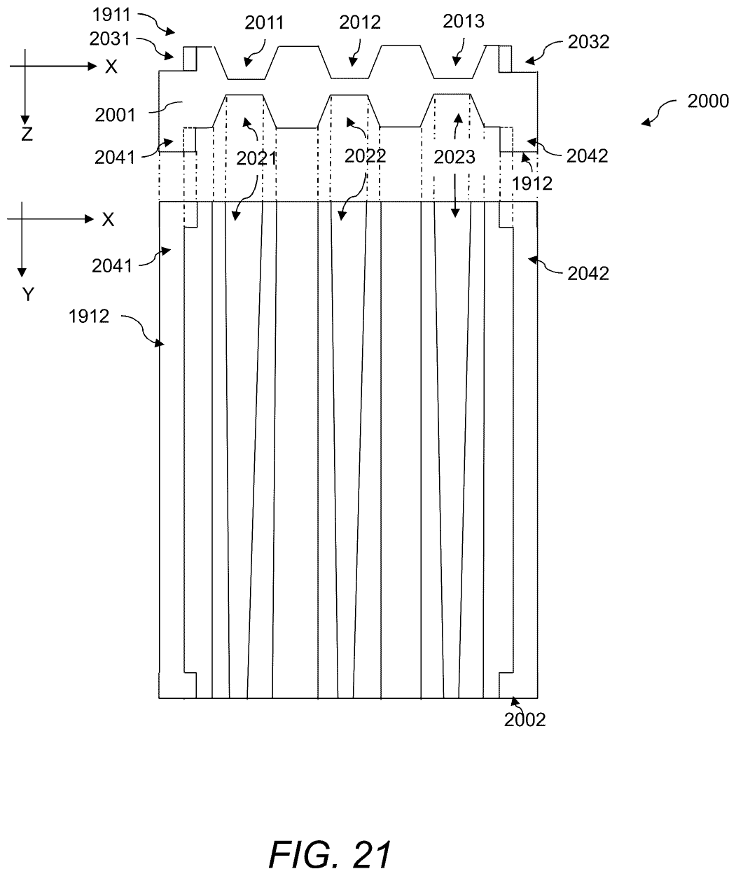

FIG. 20 is a front view and a plan view showing another example of a light guide component formed by the manufacturing system 1600. FIG. 21 is a front view and a bottom view showing another example of a light guide component formed by the manufacturing system 1600.

A light guide component 2000 is produced as a result of the manufacturing system 1600 machining the to-be-machined item 1910. That is, first grooves 2011 to 2013 are formed in the front surface 1911 of the light guide component 1900 and second grooves 2021 to 2023 are formed in the rear surface 1912.

The first grooves 2011 to 2013 and the second grooves 2021 to 2023 are substantially trapezoidal, for example, and are machined such that the shape thereof becomes gradually smaller from a front edge face 2001 to a rear edge face 2002.

Substantially U-shaped fitting grooves 2031 and 2032 are machined in both edges along the Y axis direction of the front surface 1911 of the light guide component 2000. Substantially U-shaped fitting projections 2041 and 2042 are machined in both edges along the Y axis direction of the rear surface 1912 of the light guide component 2000.

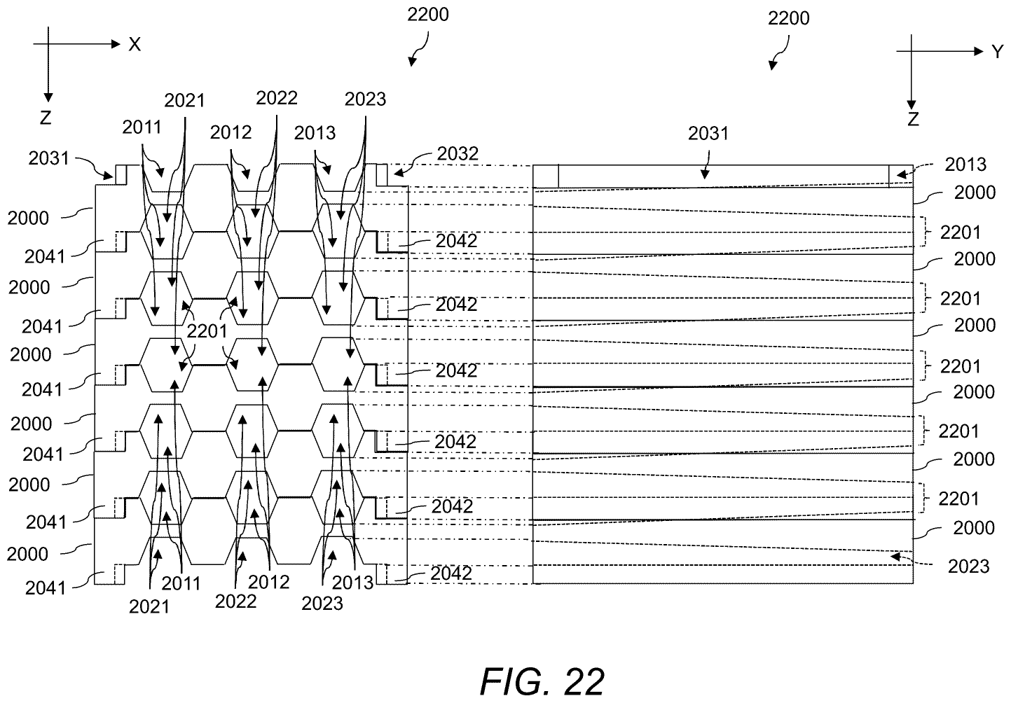

FIG. 22 is a descriptive view showing a connection example of the light guide component 2000. FIG. 22 shows a structure 2200 formed by stacking six light guide components 2000 in the Z axis direction. Specifically, six light guide components 2000 are stacked in the Z axis direction as a result of the front surfaces 1911 and the rear surfaces 1912 of two light guide components 2000 adjacent to each other in the Z axis direction being connected to each other, for example. In the structure 2200, the penetrating holes 2201 are the light guide units 101 or the frustum sections 102.

As a result of the front surfaces 1911 and the rear surfaces 1912 of two light guide components 2000 adjacent to each other in the Z axis direction being connected, the first grooves 2011 to 2013 and the second grooves 2021 to 2023 of the light guide components 2000 face each other, thereby forming the penetrating holes 2201. At this time, among the two light guide components 2000 adjacent to each other in the Z axis direction, the fitting grooves 2041 and 2042 provided on the rear surface 1912 of the upper light guide component 2000 fit with the fitting grooves 2031 and 2032 provided in the front surface 1911 of the lower light guide component 2000. As a result, offset of the light guide components 2000 in the X axis direction and the Y axis direction is restricted, thereby improving positioning accuracy of the penetrating holes 2201.

Two adjacent light guide components 2000 are connected to each other by screw or by pressure. If screws are used, a screw hole that penetrates six light guide components 2000 is formed. By shortening the pulse width of the laser beam, it is possible to mitigate the formation of burrs in the front surface 1911 and the rear surface 1912 of the to-be-machined item 1910 during machining, thereby mitigating the formation of gaps between two adjacent light guide components 2000.

In the structure 2200, the front edge face 2001 of each light guide component 2000 is the light-receiving surface and the rear edge face 2002 of each light guide component 2000 is the light-emitting surface. Below, the plurality of linked front edge faces 2001 are referred to as the light-receiving surface 2001 and the plurality of linked rear edge faces 2002 are referred to as the light-emitting surface 2002.

Light enters from the openings of the penetrating holes 2201 formed in the light-receiving surface 2001, and is emitted from the openings of the penetrating holes 2201 formed in the light-emitting surface 2002.

The structure 2200 is applied to the detection device 100 as the plurality of light guide units 101 described in Embodiments 1 to 4. Specifically, the light-emitting surface 2202 of the structure 2200 is connected to the detection processing unit 510, for example. More specifically, the detection unit 110 is connected to each of the openings of the penetrating holes 2201 on the side of the light-emitting surface 2202. As a result, it is possible to receive light passing through the penetrating holes 2201.

### Embodiment 7

Next, Embodiment 7 will be described. Embodiment 7 discloses a manufacturing method for manufacturing a light guide unit by stacking, in the plate thickness direction, plate-shaped members having a plurality of penetrating holes formed in the plate thickness direction. The same components as Embodiments 1 to 4 are assigned the same reference characters and descriptions thereof are omitted.

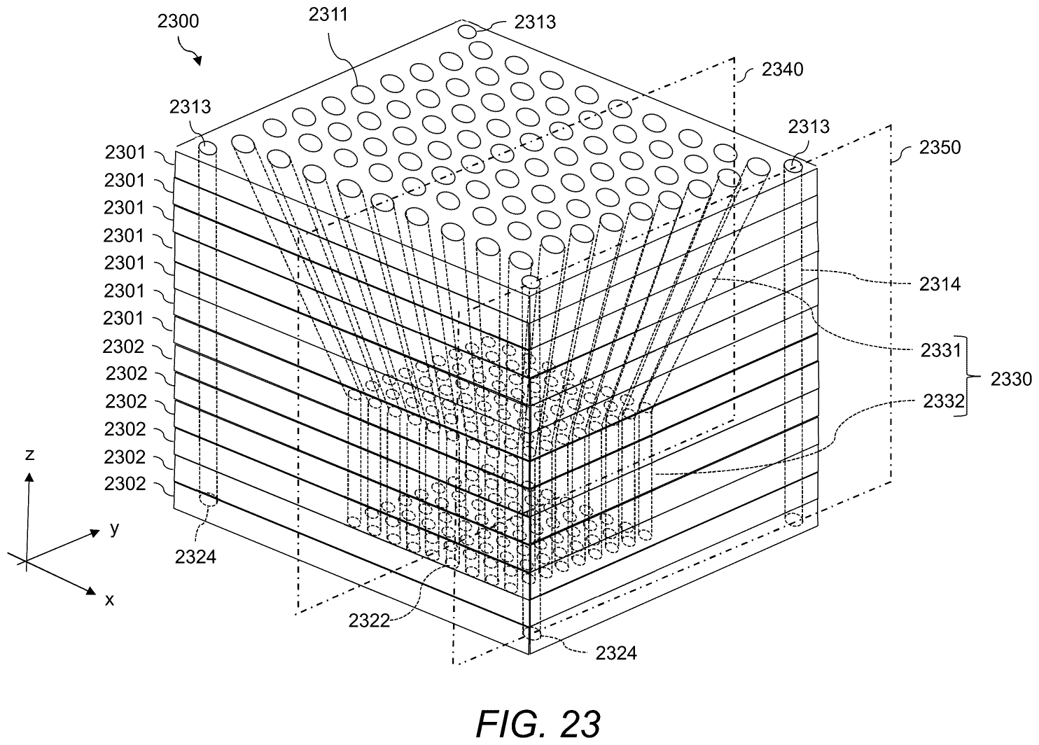

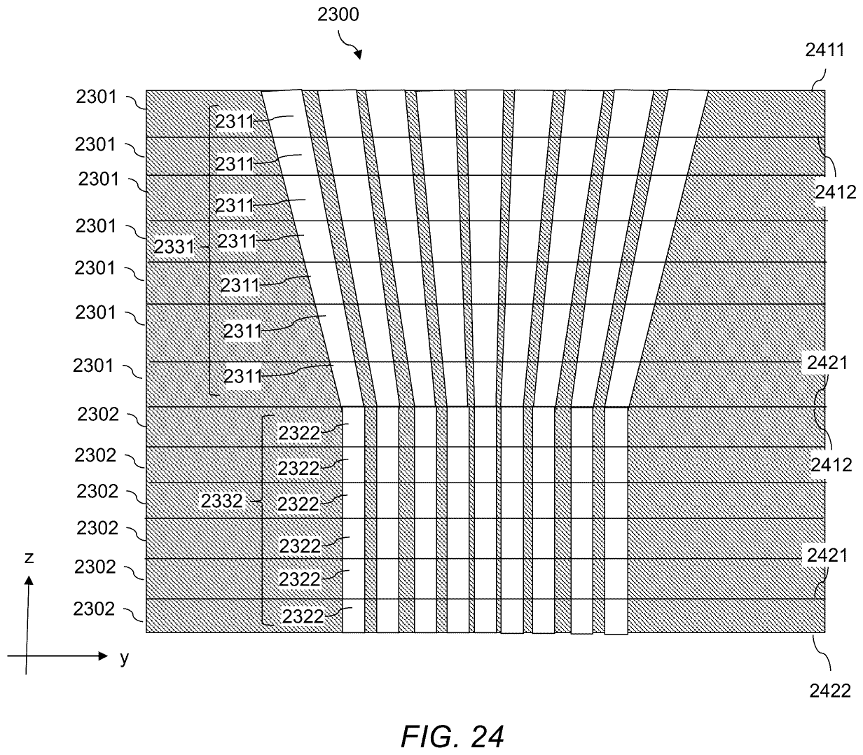

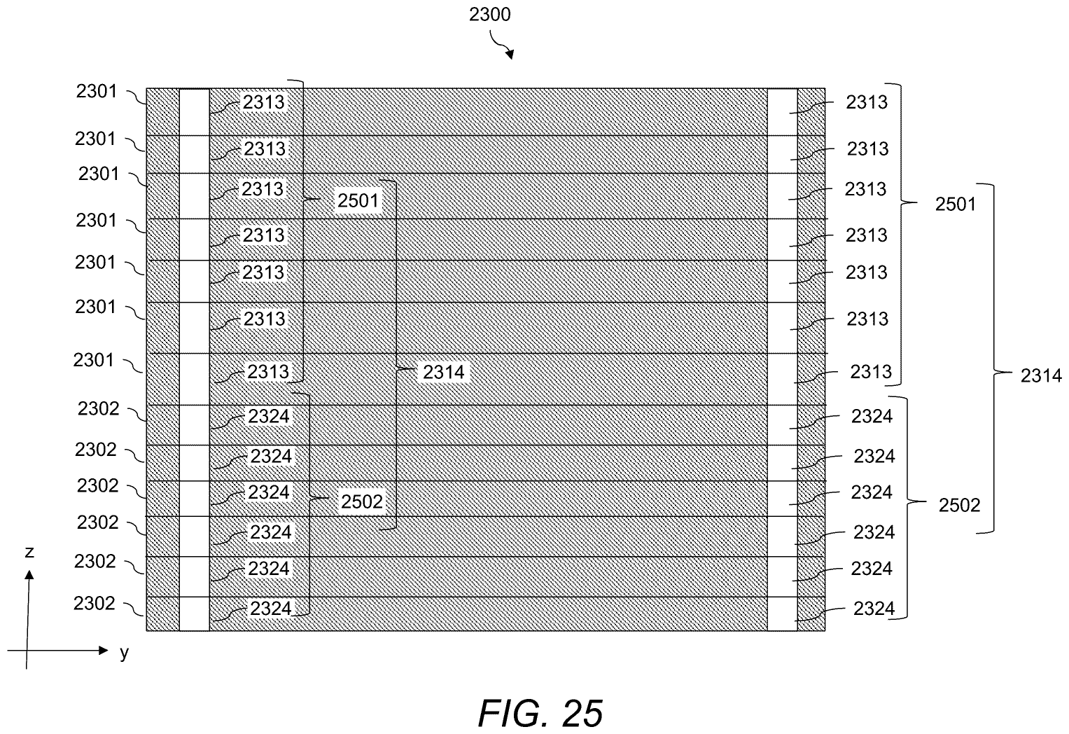

FIG. 23 is a perspective view showing an example of a structure 2300 according to Embodiment 7. FIG. 24 is a first cross-sectional view of the structure 2300 according to Embodiment 7. The cross-sectional view shown in FIG. 24 shows a cross section 2340, shown in FIG. 23, of the structure 2300. FIG. 25 is a second cross-sectional view of the structure 2300 according to Embodiment 7. The cross-sectional view shown in FIG. 25 shows a cross section 2350, shown in FIG. 23, of the structure 2300.

The structure 2300 is formed by stacking a first plate-shaped member 2301 and a second plate-shaped member 2302. The first plate-shaped member 2301 and the second plate-shaped member 2302 are stacked in the z direction. The two axes perpendicular to the z axis are the x axis and the y axis. The x axis and the y axis are perpendicular to each other.

In the examples of FIGS. 23 to 25, there are seven first plate-shaped members 2301, but the number of first plate-shaped members 2301 is not limited to seven. There are six second plate-shaped members 2302, but the number of second plate-shaped members 2302 is not limited to six. Also, the first plate-shaped members 2301 may be of any thickness, and different first plate-shaped members 2301 may have different thicknesses. Similarly, the second plate-shaped members 2302 may be of any thickness, and different second plate-shaped members 2302 may have different thicknesses. Also, the first plate-shaped members 2301 may differ in thickness from the second plate-shaped members 2302.

First, the first plate-shaped members 2301 will be described. Each of the first plate-shaped members 2301 has a plurality of first penetrating holes 2311 that are formed in substantially the z direction. Also, each of the first plate-shaped members 2301 has, at each of the four corners thereof, a third penetrating hole 2313 for positioning that is formed in the z direction. In each of the first plate-shaped members 2301, 81 first penetrating holes 2311 are arranged in a matrix. Although the number of first penetrating holes 2311 is not limited to 81, the number of first penetrating holes 2311 is the same for all of the plurality of first plate-shaped members 2301.

The diameter of the first penetrating holes 2311 is greater for first plate-shaped members 2301 that are disposed higher in the z direction, and the diameter of the first penetrating holes 2311 is smaller for first plate-shaped members 2301 that are disposed lower. As the diameter is reduced, the gap between adjacent first penetrating holes 2311 is also reduced.

A bottom surface 2412 of one first plate-shaped member 2301 and a top surface 2411 of another first plate-shaped member 2301 disposed therebelow and adjacent thereto in the z direction are in contact with each other. As a result, the first penetrating holes 2311 of the one first plate-shaped member 2301 are connected to the first penetrating holes 2311 of the other first plate-shaped member 2301. Thus, first light guide paths 2331 are formed. The same number of first light guide paths 2331 (81 in the present example) are formed as the number of first penetrating holes 2311 provided in a given first plate-shaped member 2301.

As shown in FIGS. 23 and 24, the first light guide paths 2331 are formed so as to approach the center of the bottommost first plate-shaped member 2301 from the topmost first plate-shaped member 2301 in the z direction. Also, the first plate-shaped members 2301 are formed such that the diameters of the first light guide paths 2331 become smaller from the topmost first plate-shaped member 2301 in the z direction to the bottommost first plate-shaped member 2301 as the light guide paths 2331 approach the center.

Thus, the first light guide paths 2331 have the structure of the space inside the frustum section 102 described in Embodiments 1 to 4.

Also, the third penetrating holes 2313 are provided at the same position and with the same diameter for all of the first plate-shaped members 2301. The internal circumferential surfaces of the third penetrating holes 2313 are provided with screw threading. By stacking the first plate-shaped members 2301 in the z direction, the plurality of third penetrating holes 2313 formed in the z direction are connected to each other, thereby forming first screw holes 2501.

Next, the second plate-shaped members 2302 will be described. Each of the second plate-shaped members 2302 has a plurality of second penetrating holes 2322 that are formed in the z direction. Also, each of the second plate-shaped members 2302 has, at each of the four corners thereof, a fourth penetrating hole 2324 for positioning that is formed in the z direction. In each of the second plate-shaped members 2302, 81 second penetrating holes 2322 are arranged in a matrix. Although the number of second penetrating holes 2322 is not limited to 81, the number of second penetrating holes 2322 is the same for all of the plurality of second plate-shaped members 2302.

The second penetrating holes 2322 are provided at the same position and with the same diameter for all of the plurality of second plate-shaped members 2302. A bottom surface 2422 of one second plate-shaped member 2302 and a top surface 2421 of another second plate-shaped member 2302 disposed therebelow and adjacent thereto in the z direction are in contact with each other. As a result, the second penetrating holes 2322 of the one second plate-shaped member 2302 are connected to the second penetrating holes 2322 of the other second plate-shaped member 2302 in the z direction. As a result, second light guide paths 2332 are formed. The same number of second light guide paths 2332 (81 in the present example) are formed as the number of second penetrating holes 2322 provided in a given second plate-shaped member 2302.

In this manner, the second light guide paths 2332 have the structure of the cylindrical space inside the transmission section 103 described in Embodiments 1 to 4.

Also, the fourth penetrating holes 2324 are provided at the same position and with the same diameter for all of the second plate-shaped members 2302. The fourth penetrating holes 2324 are the same shape and size as the third penetrating holes 2313, and, similar to the third penetrating holes 2313, are provided at the four corners of the second plate-shaped members 2302. The internal circumferential surfaces of the fourth penetrating holes 2324 are provided with screw threading. By stacking the second plate-shaped members 2302 in the z direction, the plurality of fourth penetrating holes 2324 formed in the z direction are connected to each other, thereby forming second screw holes 2502.

Next, the boundary between the first plate-shaped member 2301 and the second plate-shaped member 2302 will be described. The bottommost first plate-shaped member 2301 among the plurality of first plate-shaped members 2301 is connected to the topmost second plate-shaped member 2302 among the plurality of second plate-shaped members 2302. Specifically, the bottom surface 2412 of the bottommost first plate-shaped member 2301 is in contact with the top surface 2421 of the topmost second plate-shaped member 2302.

Also, the diameter of the first penetrating hole 2311 of the bottommost first plate-shaped member 2301 at the bottom surface 2412 side is the same as the diameter of the second penetrating hole 2322. The first penetrating holes 2311 of the bottommost first plate-shaped member 2301 are provided at positions so as to connect to the second penetrating holes 2322 when the topmost second plate-shaped member 2302 is in contact with the bottommost first plate-shaped member 2301. Thus, the first light guide paths 2331 are connected to the second light guide paths 2332 as a result of the plurality of first plate-shaped members 2301 and the plurality of second plate-shaped members 2302 being stacked. As a result, penetrating holes 2330 are formed.

Also, the third penetrating holes 2313 of the bottommost first plate-shaped member 2301 are provided at positions so as to connect to the fourth penetrating holes 2324 when the topmost second plate-shaped member 2302 is in contact with the bottommost first plate-shaped member 2301. Thus, the first screw holes 2501 are connected to the second screw holes 2502 as a result of the plurality of first plate-shaped members 2301 and the plurality of second plate-shaped members 2302 being stacked. As a result, the fourth penetrating holes 2314 are formed. As a result of screws (not shown) being screwed into the four fourth penetrating holes 2314, the plurality of first plate-shaped members 2301 and the plurality of second plate-shaped members 2302 are fixed to each other.

Aside from connection by screws, the structure 2300 may be formed by connecting by pressure the first plate-shaped members 2301 adjacent to each other in the z direction, connecting by pressure the second plate-shaped members 2302 adjacent to each other in the z direction, and connecting by pressure the first plate-shaped member 2301 and the second plate-shaped member 2302 adjacent to each other in the z direction.

By mounting the first plate-shaped members 2301 on the XY stage 1602 of the manufacturing system 1600 of Embodiment 6, and emitting the laser beam from the laser beam machine 1601, the first penetrating holes 2311 and the third penetrating holes 2313 are formed. In this case, the XY stage 1602 would be inclined in relation to the Z axis direction such that the first plate-shaped members 2301 are inclined in relation to the Z axis direction, or the emission direction of the laser beam from the laser beam machine 1601 would be inclined in the Z axis direction.

Also, by mounting the second plate-shaped members 2302 on the XY stage 1602 of the manufacturing system 1600, and emitting the laser beam from the laser beam machine 1601, the second penetrating holes 2322 and the fourth penetrating holes 2324 are formed.

The structure 2300 is applied to the detection device 100 as the plurality of light guide units 101 described in Embodiments 1 to 4. Specifically, the bottom surface 2422 of the bottommost second plate-shaped member 2301 of the structure 2300 is connected to the detection processing unit 510, for example. More specifically, the detection unit 110 is connected to each of the openings of the second penetrating holes 2322 on the side of bottom surface 2422 of the bottommost second plate-shaped member 2302. As a result, it is possible to receive light passing through the first light guide paths 2331 and the second light guide paths 2332.

Also, the structure 2300 may be constituted of the plurality of first plate-shaped members 2301 without use of the plurality of second plate-shaped members 2302. In this case, the bottom surface 2412 of the bottommost first plate-shaped member 2301 of the structure 2300 is connected to the detection processing unit 510. More specifically, the detection unit 110 is connected to each of the openings of the of first penetrating holes 2321 on the side of bottom surface 2412 of the bottommost first plate-shaped member 2301. As a result, it is possible to receive light passing through the first light guide paths 2331.

Also, in the structure 2300, the first light guide paths 2331 that are positioned further to the outside are configured to be more inclined towards the central first light guide path 2331, but the first light guide paths 2331 may be formed such that the internal circumferential surfaces thereof are parallel to the z axis. Details are explained below.

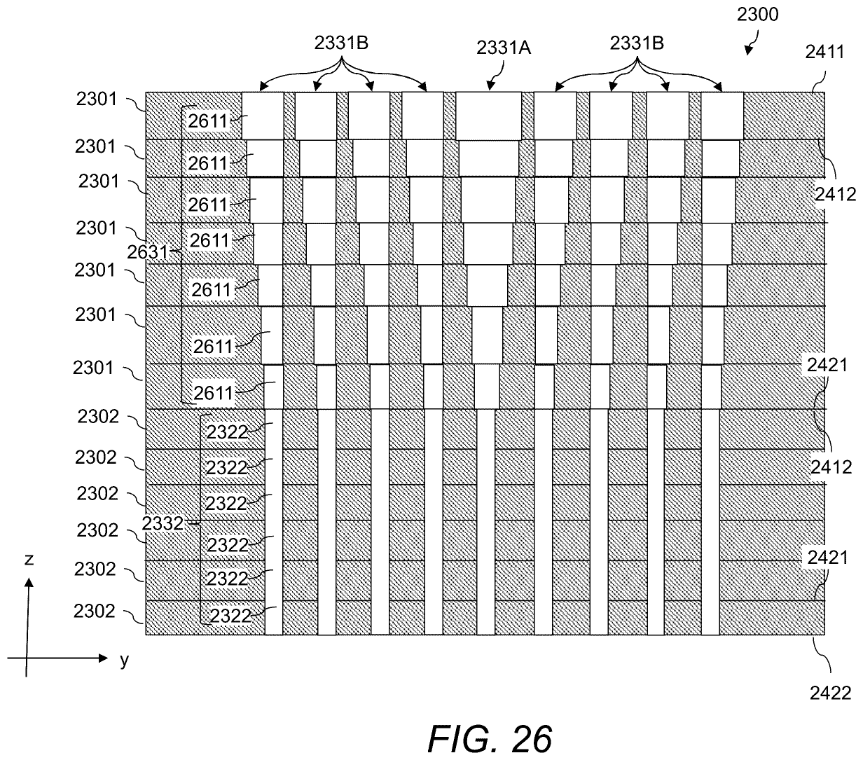

FIG. 26 is another first cross-sectional view of the structure 2300 according to Embodiment 7. The cross-sectional view shown in FIG. 26 shows a cross section 2340, shown in FIG. 23, of the structure 2300. In FIG. 26, differences from FIG. 24 will primarily be explained.

First, the first plate-shaped members 2301 will be described. Each of the first plate-shaped members 2301 has a plurality of first penetrating holes 2611 that are formed in substantially the z direction. In each of the first plate-shaped members 2301, 81 first penetrating holes 2611 are arranged in a matrix. Although the number of first penetrating holes 2611 is not limited to 81, the number of first penetrating holes 2611 is the same for all of the plurality of first plate-shaped members 2301.

The diameter of the first penetrating holes 2311 is greater for first plate-shaped members 2301 that are disposed higher in the z direction, and the diameter of the first penetrating holes 2311 is smaller for first plate-shaped members 2301 that are disposed lower. However, unlike FIGS. 23 and 24, in each of the first plate-shaped members 2301, the central first penetrating hole 2611 has a greater diameter than the other first penetrating holes 2611.

Here, the first light guide path 2631 formed from the central first penetrating holes 2611 of the plurality of first plate-shaped members 2301 is designated as the first light guide path 2631A, and the other first light guide paths 2631 are designated as the first light guide paths 2631B.

The first light guide path 2631A has stepwise generatrices, on both sides in the y direction, for the internal circumferential surface of the first penetrating hole 2611 in the first cross section.

The first light guide paths 2631B, similar to the first light guide path 2631A, also have stepwise generatrices for the internal circumferential surfaces of the first penetrating holes 2611 away from the first light guide path 2631A, in the first cross section. By contrast, the generatrices of the internal circumferential surfaces, of the first penetrating holes 2611, closer to the first light guide path 2631A are straight lines.

Thus, since the first light guide paths 2631A and 2631B are provided with a stepwise configuration, a similar function to that of the light reception prevention member 402 of Embodiment 1 is provided. Thus, the incident light can be reflected in a similar manner to the light reception prevention member 402.

By mounting the first plate-shaped members 2301 on the XY stage 1602 of the manufacturing system 1600 of Embodiment 6, and emitting the laser beam from the laser beam machine 1601, the first penetrating holes 2611 and the third penetrating holes 2313 are formed. Similarly, by mounting the second plate-shaped members 2302 on the XY stage 1602 of the manufacturing system 1600, and emitting the laser beam from the laser beam machine 1601, the second penetrating holes 2622 and the fourth penetrating holes 2324 are formed.

Thus, the first penetrating holes 2611 are formed in a direction (z direction) perpendicular to the top surface 2411 of the first plate-shaped member 2301. Therefore, in the manufacturing system 1600, the laser beam from the laser beam machine 1601 can be emitted perpendicular to the top surface 2411, allowing for easy machining control in the manufacturing system 1600.

Also, in addition to machining by laser beam, the first plate-shaped members 2301 may be drilled to form the first penetrating holes 2611 and the third penetrating holes 2313. Similarly, the second plate-shaped members 2302 may be drilled to form the second penetrating holes 2612 and the fourth penetrating holes 2314.

The present embodiment is not limited to the content above, and the content above may be freely combined. Also, other aspects considered to be within the scope of the technical concept of the present embodiment are included within the scope of the present embodiment.

### DESCRIPTION OF REFERENCE CHARACTERS

100 detection device
101 light guide unit
102 frustum section
103 transmission section
110 detection unit
112 light reception surface
121 light incidence section
121a light incidence opening
123 penetrating hole
132a light emission opening
133 transmission path
401 internal circumferential surface
402 light reception prevention member
500 detection device
510 detection unit

1. A detection device, comprising:
a light guide unit having a light incidence opening for entry of light and a light emission opening smaller in size than the light incidence opening, the light entering through the light incidence opening being emitted through the light emission opening; and
a detection unit configured to detect the light emitted through the light emission opening.

2. The detection device according to claim 1,
wherein the light guide unit has a penetrating hole with a frustum shape having the light incidence opening and the light emission opening, and configured to emit the light entering through the light incidence opening via the penetrating hole and through the light emission opening.

3. The detection device according to claim 1,
wherein an edge of the light incidence opening has a light incidence edge positioned at a first distance from a center of the light incidence opening, and another light incidence edge other than the aforementioned light incidence edge positioned at the first distance from the center of the light incidence opening, and
wherein an edge of the light emission opening has a light emission edge positioned at a second distance, shorter than the first distance, from a center of the light emission opening, and another light emission edge other than the aforementioned light emission edge positioned at the second distance from the center of the light emission opening.

4. The detection device according to claim 3,
wherein the light incidence opening and the light emission opening have a circular shape.

5. The detection device according to claim 1,
wherein an edge of the light incidence opening has a light incidence edge positioned at a third distance from a center of the light incidence opening, and another light incidence edge other than the aforementioned light incidence edge positioned at a fourth distance, shorter than the third distance, from the center of the light incidence opening, and
wherein an edge of the light emission opening has a light emission edge positioned at a fifth distance, shorter than the third distance, from a center of the light emission opening, and another light emission edge other than the aforementioned light emission edge positioned at a sixth distance, shorter than the fifth distance, from the center of the light emission opening.

6. The detection device according to claim 5,
wherein the light incidence opening and the light emission opening have a polygonal shape.

7. The detection device according to claim 6,
wherein the polygonal shape is a hexagon.

8. The detection device according to claim 1,
wherein an internal circumferential surface of the light guide unit is a reflective surface that reflects light.

9. The detection device according to claim 1,
wherein an internal circumferential surface of the light guide unit has a member that reflects light in a direction towards the light incidence opening.

10. The detection device according to claim 9,
wherein the detection unit is provided in the light emission opening.

11. The detection device according to claim 1,
wherein the light incidence opening has a member that condenses light in a direction towards the light emission opening.

12. The detection device according to claim 1,
wherein the light guide unit has a transmission section that transmits light.

13. The detection device according to claim 12,
wherein the transmission section has a first end that allows light from the light incidence opening to enter and a second end that emits the light that has entered the first end.

14. The detection device according to claim 13,
wherein an opening of the first end of the transmission section and an opening of the second end are substantially the same size.

15. The detection device according to claim 1,
wherein the detection unit is made of indium gallium arsenide.

16. The detection device according to claim 1,
wherein a plurality of the light guide units are disposed such that the light incidence openings thereof are separated from each other.

17. The detection device according to claim 16,
wherein a plurality of the light guide units are disposed radially in directions from the light emission openings towards the light incidence openings.

18. The detection device according to claim 16,
wherein the detection unit has photodiodes, and
wherein the photodiodes are arranged in two dimensions.

19. The detection device according to claim 16,
wherein the light guide units each have a transmission section including a first end that allows light from the light incidence opening to enter and a second end that emits the light that has entered the first end, and
wherein, among the plurality of light guide units, a light guide unit further outside than the light guide unit positioned at a center of the detection unit has a shorter length for the transmission section that transmits light from the first end to the second end between the light incidence opening and the light emission opening.

20. The detection device according to claim 17,
wherein the light guide units each have a transmission section including a first end that allows light from the light incidence opening to enter and a second end that emits the light that has entered the first end, and
wherein, among the plurality of light guide units, a light guide unit further outside than the light guide unit positioned at a center of the detection unit does not have the transmission section.

21. The detection device according to claim 16,
wherein the plurality of light guide units are disposed in a substantially semi-spherical arrangement.
